(19) United States
(12) Patent Application Publication
(10) Pub. No.: US 2007/0262764 A1
(43) Pub. Date: Nov. 15, 2007

(54) Power supply circuit device and electronic apparatus provided therewith

(75) Inventors: Hirohisa Warita, Kitakatsuragi-gun (JP); Tadamasa Kimura, Tenri-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/797,866

(22) Filed: May 8, 2007

(30) Foreign Application Priority Data
May 9, 2006 (JP) 2006-129797

(51) Int. Cl. G05F 1/00

(52) U.S. Cl. 323/284

(57) ABSTRACT

A control circuit device 6 is supplied with a buffer circuit 71 that has an input side thereof connected to a PWM input terminal PWN, and the buffer circuit 71 transforms a PWM signal being supplied from the outside to obtain a waveform, whereby an “H” level of a PWM signal that is inputted to an error amplifier 68 by way of an RC filter 8 can be made constant. As a result, it is possible to control an output current to be supplied to the load 7 even when the output current to the load 7 is minimal.

This non-provisional application claims priority under 35 U.S.C. § 119(a) on Patent Application No. 2006-129797 being filed in Japan on May 9, 2006, the entire contents of which are hereby incorporated by reference.

### BACKGROUND OF THE INVENTION

1. Field of the Invention

The present invention relates to power supply circuit devices, which step up or step down an input voltage being supplied from a direct current power source to feed it to a load, and to electronic apparatuses being provided with such power supply circuit devices. The present invention especially relates to power supply circuit devices, which adjust the electric power to be supplied to a load based on the Pulse Width Modulation (PWM) signals; and to electronic apparatuses being provided with such power supply circuit devices.

2. Description of the Prior Art

In recent years, white light-emitting diodes (white LEDs) that are excellent in durability, luminous efficiency, space-saving and the like, have come to be employed as one of the illumination light sources (backlights or front-lights) of liquid crystal display devices (LCDs) that are installed to portable electronic apparatuses such as cellular phones, personal digital assistants (PDAs), digital cameras and the like. The white LEDs need a relatively high forward voltage, and normally, employ a plurality of white LEDs as an illumination light source. The plurality of white LEDs that are employed as the illumination light source are connected in series in order to achieve uniform brightness of each white LED. Considering the above, a direct current voltage that is higher than a direct current voltage being supplied from a battery that is housed in a portable electronic apparatus is required in order to drive the white LEDs as the illumination light source.

In addition, along with the miniaturization of communications apparatuses that is achieved by the advancements in communications technology, video has been distributed to the portable electronic apparatuses. Some of such portable electronic apparatuses as can receive video in such a manner as mentioned hereinabove have a digital tuner, for example, mounted thereto. In order to drive the digital tuner, however, a voltage of 30V to 40V is required as a voltage source. Therefore, the portable electronic apparatuses having such a capability as mentioned hereinabove also require a direct current voltage that is higher than a direct current voltage being supplied from a battery being housed therein.

In consequence, the portable electronic apparatuses that are described as hereinabove employ a stepping-up power supply circuit device in order to step up a direct current voltage that is supplied from a battery being housed therein. Among these power supply circuit devices, is provided a switching power source device, that is a power supply circuit device being equipped with a soft starting circuit that gradually drives a power supply circuit device when the power supply is turned ON, so that the switching element will be prevented from getting damaged. (Patent Application Laid Open as H11-69793) The switching power supply device that is disclosed in the Patent Application Laid Open as H11-69793 can start operation of the soft starting circuit in case of a temporary blackout or in a case where the power source is turned ON again in a short time, by forcing the soft starting capacitor to discharge electricity when a transition at a voltage of the predetermined voltage or less of the power supply of operation is detected.

Additionally, a power supply circuit device that is provided with a switching element being driven based on a PWM signal is employed as a power supply circuit device that is employed for the above-mentioned portable electronic apparatuses. FIG. 18 shows a configuration of a conventional power supply circuit device being provided with a switching element that behaves based on the PWM signal. The power supply circuit device shown in FIG. 18 comprises a direct current power source 1 such as a lithium ion battery and the like; an input capacitor 2 that is connected in parallel with the direct current power source 1; a coil 3 that has one end thereof connected to the node between the input capacitor 2 and a positive terminal (the supplied voltage side) of the direct current power source 1; a diode 4 that serves as a rectifying element whose anode is connected to the other end of the coil 3; an output capacitor 5 that is connected to the cathode of the diode 4; and a control circuit device 60 that is formed as an IC being mounted in a single package and that performs stepping-up operation by storing the energy in the coil 3 or discharging the energy from the coil 3. In addition, the direct current power source 1, the input capacitor 2, and the output capacitor 5 are grounded on the sides thereof that are opposite to the supplied voltage (the sides thereof on the negative side of the direct current power source 1).

One end of a load 7 is connected to the cathode of the diode 4 so that a voltage being stepped up by this power supply circuit device is applied to the load 7. A resistor R1 having one end thereof grounded is connected, at the other end thereof, to the other end of the load 7; and an RC filter 8 that passes a PWM signal being supplied from the outside there-through and adds the PWM signal to a voltage signal appearing to the node at which the load 7 and the resistor R1 are connected together is connected to a feedback signal input terminal FB of the control circuit device 60. In addition, the control circuit device 60 is provided with an input-voltage input terminal Vi that is connected to the supplied potential side of the direct current 1; a control terminal Vsw that is connected to the node between the coil 3 and the diode 4 so as to control the amount of electric current flowing through the coil 3; a control signal input terminal CTRL that is supplied with an ON or OFF state control signal that controls the ON or OFF performance of the power supply circuit device; and a ground terminal GND that is grounded.

The control circuit device 60 comprises an N-channel metal-oxide-semiconductor (MOS) field effect transistor Tr1 (a power transistor Tr1) that has a control terminal Vsw and a drain connected together; a resistor R4 that has one end thereof connected to a source of the power transistor Tr1 and has the other end thereof connected to the ground terminal GND so as to be grounded; a constant voltage circuit 61 that transforms a direct current voltage being supplied from the direct current power source 1 through the input-voltage input terminal Vi into a constant direct current voltage to be applied to each different block that is provided inside the control circuit device 60; a soft starting circuit 62 that gradually drives a power supply circuit device when the power source is turned ON; an ON/OFF state control circuit 63 that controls the ON or OFF performance of the power supply circuit device by being supplied with an ON or OFF state control signal being provided to the control signal input terminal CTRL; a drive circuit 64 that switches over a voltage being fed to the gate of the power transistor Tr1; a current-detecting comparator 65 that has an input side thereof connected to both ends of the resistor R4; an oscillation circuit 66 that supplies an oscillating signal serving as a reference waveform for producing a PWM signal; an adding circuit 67 that adds an oscillating signal being supplied from the oscillation circuit 66 to an output being supplied from the current-detecting comparator 65; an error amplifier 68, wherein a feedback signal being supplied from the feedback signal input terminal FB is received at the inverting input terminal thereof; and a PWM comparator 69, wherein an output of the error amplifier 68 is received at the inverting input terminal thereof and an oscillating signal being supplied from the adding circuit 67 is received at the non-inverting input terminal thereof.

In addition, in order to supply a reference voltage Vref to the non-inverting input terminal of the error amplifier 68, the control circuit device 60 is provided with the resistors R2 and R3 that are connected in series so as to divide the voltage being supplied from the constant voltage circuit 61, and the non-inverting input terminal of the error amplifier 68 is connected to the node between the resistors R2 and R3. Furthermore, the RC filter 8 includes a resistor R5 that has one end thereof connected to the node between the load 7 and the resistor R1 and has the other end thereof connected to the feedback signal input terminal FB; a resistor R6 that has one end thereof connected to the feedback signal input terminal FB; a resistor R7 that has one end thereof connected to the other end of the resistor R6 and receives a PWM signal being supplied from the outside at the other end thereof; and a capacitor C1 that has one end thereof connected to the node between the resistors R6 and R7 and has the other end thereof grounded.

In the power supply circuit device that is provided with a control circuit device 60 being configured in such a manner as described hereinabove, when turning “ON” of the power supply circuit device is instructed by having an ON or OFF state control signal supplied from the outside, the ON/OFF state control circuit 63 starts to drive the power transistor Tr1 by the drive circuit 64. At this time, in order to make the soft starting function of the soft starting circuit 62 operate, the duty ratio of a drive signal being supplied to the gate of the power transistor Tr1 from the drive circuit 64 is gradually increased, so that the “ON” time of the power transistor Tr1 will be extended gradually, and then finally, the power transistor Tr1 will be operated for the predetermined ON/OFF period.

Then, during normal performance of the control circuit device 60, when the power transistor Tr1 is turned ON by the drive circuit 64, an electric current from the direct current power source 1 flows through the coil 3, whereby the energy is stored in the coil 3. When the power transistor Tr1 is turned OFF by the drive circuit 64, the energy that is stored in the coil 3 is discharged, whereby back electromotive force is generated in the coil 3.

The back electromotive force that is generated in the coil 3 is added to the input voltage being supplied from the direct current power source 1, and charges the output capacitor 5 by way of the diode 4. To be specific, the voltage occurring on the side of the coil 3 at which the coil 3 is connected to the diode 4 is equalized by the diode 4 and the output capacitor 5. By repeating a series of such behaviors as described hereinabove, stepping-up operation is performed, wherein an output voltage is generated on both ends of the output capacitor 5. This output voltage makes an output current flow to the load 7. In addition, in a case where a white LED is employed as the load 7, the output current flows to the white LED, thereby making the white LED emit light.

Since the output current flowing through the load 7 also flows through the resistor R1, a voltage that is obtained by multiplying the electric current value of this output current by the resistance value of the resistor R1 is supplied to the RC filter 8 as a feedback signal. When a feedback signal is supplied to the feedback signal input terminal FB of the control circuit device 60 by way of the resistor R5 of the RC filter 8, the feedback signal is supplied to the inverting input terminal of the error amplifier 68. In the error amplifier 68, a difference between the reference potential Vref appearing to the node between the resistors R2 and R3 and the potential of the feedback signal is obtained, and then, an output signal in accordance with the difference that is obtained as mentioned hereinabove is supplied to the inverting input terminal of the PWM comparator 69.

In addition, by having the electric current, which flows when the power transistor Tr1 is turned ON, flow through the resistor R4, the voltage appearing to both ends of the resistor R4 is supplied to the current-detecting comparator 65, and then, the current-detecting comparator 65 supplies the adding circuit 67 with a voltage signal that is proportional to the electric current flowing through the power transistor Tr1. The adding circuit 67 adds a voltage signal being supplied from the current-detecting comparator 65 to an oscillating signal in a form of saw-tooth wave being supplied from the oscillation circuit 66, which will be supplied to the non-inverting input terminal of the PWM comparator 69.

The PWM comparator 69 compares an oscillating signal being supplied from the adding circuit 67 with an output signal of the error amplifier 68. As the result of comparison, during a period in which the voltage level of the output signal of the error amplifier 68 is lower than the signal level of the oscillating signal being outputted from the adding circuit 67, a PWM signal of the PWM comparator 69 takes an “H” (High) level; and during a period in which the voltage level of the output signal of the error amplifier 68 is higher than the signal level of the oscillating signal being outputted from the adding circuit 67, the PWM signal of the PWM comparator 69 takes an “L” (Low) level.

The drive circuit 64 receives the resultant PWM signal of the PWM comparator 69, and thereby, controls the ON/OFF state of the power transistor Tr1 with a duty ratio commensurate with the PWM signal being received, by synchronizing with a clock signal that is outputted from the oscillation circuit 66. To be specific, when the PWM signal of the PWM comparator 69 takes an “L” level and when each cycle of the clock signal being outputted from the oscillation circuit 66 starts, the drive circuit 64 turns the power transistor Tr1 ON by supplying a predetermined gate voltage to the power transistor Tr1. When the PWM signal of the PWM comparator 69 takes an “H” level, the drive circuit 64 turns the power transistor Tr1 OFF by stopping the supply of the gate voltage to the power transistor Tr1.

When the ON/OFF state control of the power transistor Tr1 is performed in such a manner as mentioned hereinabove, stepping-up operation is performed in a manner that the signal level of a feedback signal that is inputted to the feedback signal input terminal FB becomes equal to the reference potential Vref. To be specific, an output current to the load 7 is stabilized to be a current value that is obtained by dividing the reference potential Vref by the resistance value of the resistor R1.

Then, in order to control the current value of the output current flowing to the load 7, a PWM signal is supplied to the RC filter 8 from the outside. To be specific, in the RC filter 8, a feedback signal that is supplied by way of the resistor R5 by a voltage appearing to the resistor R1 is added to a PWM signal that is supplied from the outside by way of the resistors R6 and R7 and the capacitor C1 serving as a filter, so as to be supplied to the feedback signal input terminal FB. In consequence, depending on the duty ratio of a PWM signal that is supplied to the RC filter 8 from the outside, the duty ratio of the PWM signal of the PWM comparator 69 varies. As a result, the ON/OFF period of the power transistor Tr1 will be changed, thereby controlling the electric current value of the output current that is supplied to the load 7.

The power supply circuit device as shown in FIG. 18 can change the amount of the output current to be supplied to the load 7 by the duty ratio of a PWM signal that is supplied to the RC filter 8 from the outside. In consequence, when a white LED is employed as the load 7, the brightness can be adjusted by changing the amount of the electric current flowing through the white LED. To be specific, a PWM signal that is supplied to the RC filter 8 from the outside is utilized as a brightness-adjusting signal for adjusting the brightness of the white LED.

However, as shown in FIG. 19, since the value of the “H” level of a PWM signal that is supplied from the outside is not constant, the “H” level of the PWM signal being supplied from the outside varies, whereby the value of a signal being inputted to the feedback signal input terminal FB varies. Therefore, the relationship between the duty ratio of the PWM signal that is supplied from the outside and the amount of the output current that is supplied to the load 7 collapses, and in consequence, it is impossible to make such an ideal adjustment of the amount of the output current to be supplied to the load 7, depending on the duty ratio of a PWM signal being supplied from the outside, as is indicated in a solid line A in the graph in FIG. 20. As a result, against the duty ratio of the PWM signal being supplied from the outside, the amount of the output current to be supplied to the load 7 varies as shown in the region B in the graph in FIG. 20.

Therefore, when the duty ratio of a PWM signal that is supplied from the outside is high, such as 95% and the like, there is sometimes no flow of the output current to the load 7 because the amount of the output current to be supplied to the load 7 varies based on a change in the value of the signal level of the PWM signal that is supplied from the outside, although it is ideal that a minimal amount of the output current flows to the load 7. Therefore, it is necessary to specify the duty ratio against the value of an output current, but the linearity of the relationship between the output current and the duty ratio fails. Moreover, in order to provide the linearity to the relationship between the output current to be supplied to the load 7 and the duty ratio of a PWM signal being supplied from the outside so as to be close to the ideal linearity, a resistance of a large value is required when the total of the resistance values of the resistors R5 through R7 in the RC filter 8 is specified to be 1 Mb.

### SUMMARY OF THE INVENTION

In view of conventionally experienced problems as described hereinabove, an object of the present invention is to provide power supply circuit devices that are configured in such a manner as the value of an electric current to be supplied to a load from the outside can be controlled easily.

In order to achieve the above object, according to one aspect of the present invention, a power supply circuit device comprises: a voltage transforming circuit that is connected to a direct current power source; a rectifying circuit that is connected to the voltage transforming circuit; a first switching element that adjusts an electric power to be supplied to the rectifying circuit by switching over the voltage transforming circuit; a drive circuit that controls an ON/OFF state of the first switching element; a current-detecting circuit that detects an electric current flowing through a load being connected to the rectifying circuit; a PWM signal producing circuit that produces a first PWM signal for instructing the control of the ON/OFF state being performed by the drive circuit by comparing, with a reference value, the signal level of a current-detecting signal indicating the value of an electric current being detected by the current-detecting circuit; and a buffer circuit into which a second PWM signal is inputted to control the value of the electric current flowing through the load from the outside and in which an element serving as a last stage is biased by the internal constant voltage being fed from the first constant voltage circuit and the second PWM signal is formed to obtain a waveform so as to be outputted.

According to the present invention, since a buffer circuit that transforms a second PWM signal being supplied from the outside into a waveform is supplied, there is no such significant deviation from a linear relationship between the duty ratio of a PWR signal being supplied from the outside and the output current of a load, due to a variation of the signal level of the PWM signal being supplied from the outside, as conventionally is. Therefore, being compared with conventional power source circuit devices, the power source circuit devices in accordance with the present invention can control a second PWM signal being supplied from the outside until the output current becomes minimal. In addition, by providing a second switching element that can disconnect an electrical connection of the load, when a power source circuit device is turned OFF, an electric current can be prevented from leaking to the load by turning the second switching element OFF. Moreover, by controlling the second switching element by the second PWM signal, the output current to be supplied to the load can be adjusted easily. Furthermore, by switching over a reference value that is supplied to the PWM signal producing circuit, the output current to be supplied to a load can be adjusted, thereby making it possible to adjust a minimal output current that cannot be adjusted by the second PWM signal that is supplied from the outside.

### BRIEF DESCRIPTION OF THE DRAWINGS

FIG. 1 is a block diagram showing the internal configuration of a power supply circuit device in accordance with a first embodiment of the present invention;

FIG. 2 is a circuit diagram showing the configuration of a constant voltage circuit, a buffer circuit and an RC filter;

FIG. 3 is a circuit diagram showing the configuration when the configuration of the constant voltage circuit is different from the configuration shown in FIG. 2;

FIG. 4 is a timing chart showing the state of a signal in each portion inside the buffer circuit;

FIG. 5 is a graph showing the relationship between the current value of a load and the duty ratio of a PWM signal being supplied from the outside:

FIG. 6 is a block diagram showing the configuration when a capacitor composing an RC filter is installed inside the control circuit device;

FIG. 7 is a block diagram showing the internal configuration of a power supply circuit device in accordance with a second embodiment;

FIG. 8 is a circuit diagram showing the configuration of a reference potential switching circuit;

FIG. 9 is a block diagram showing the internal configuration of a power supply circuit device in accordance with a third embodiment;

FIG. 10 is a block diagram showing the internal configuration of a power supply circuit device in accordance with a fourth embodiment;

FIG. 11 is a block diagram showing another configuration of a power supply circuit device in accordance with the fourth embodiment;

FIG. 12 is a block diagram showing the internal configuration of a power supply circuit device in accordance with a fifth embodiment;

FIG. 13 is a block diagram showing the internal configuration of a power supply circuit device in accordance with a sixth embodiment;

FIG. 14 is a block diagram showing the internal configuration of a power supply circuit device in accordance with a seventh embodiment;

FIG. 15 is a block diagram showing the internal configuration of a power supply circuit device in accordance with an eight embodiment;

FIG. 16 is a circuit diagram showing the configuration of a delay circuit;

FIG. 17 is a timing chart showing the state of a signal of each portion inside the delay circuit;

FIG. 18 is a block diagram showing the internal configuration of a conventional power supply circuit device;

FIG. 19 is a diagram showing the state of a PWM signal being supplied from the outside; and

FIG. 20 is graph showing the relationship between the current value of a load and the duty ratio of a PWM signal being supplied from the outside.

### DETAILED DESCRIPTION OF PREFERRED EMBODIMENTS

### First Embodiment

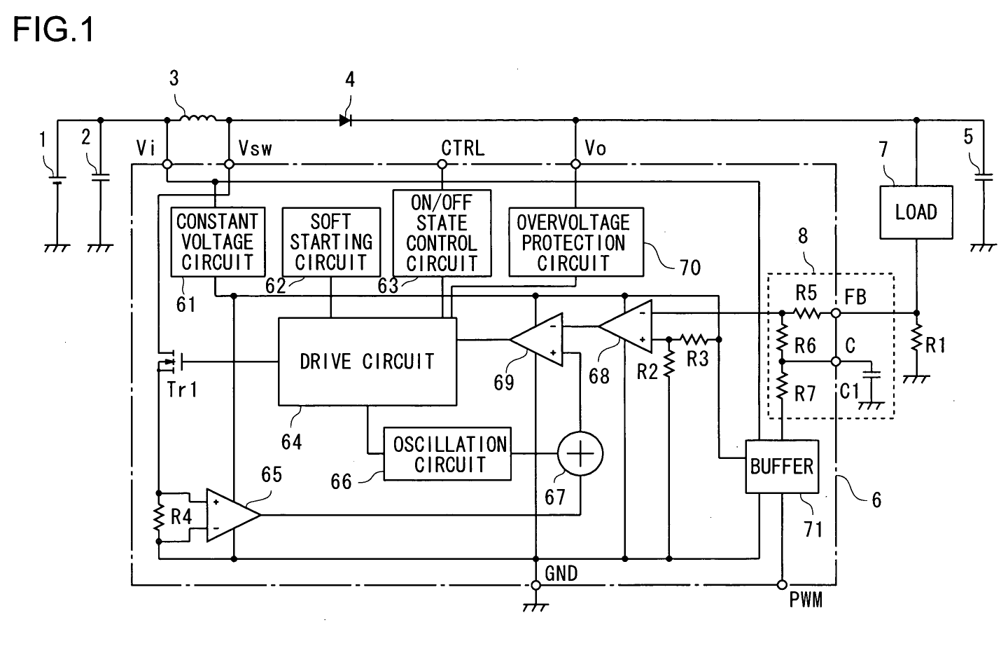

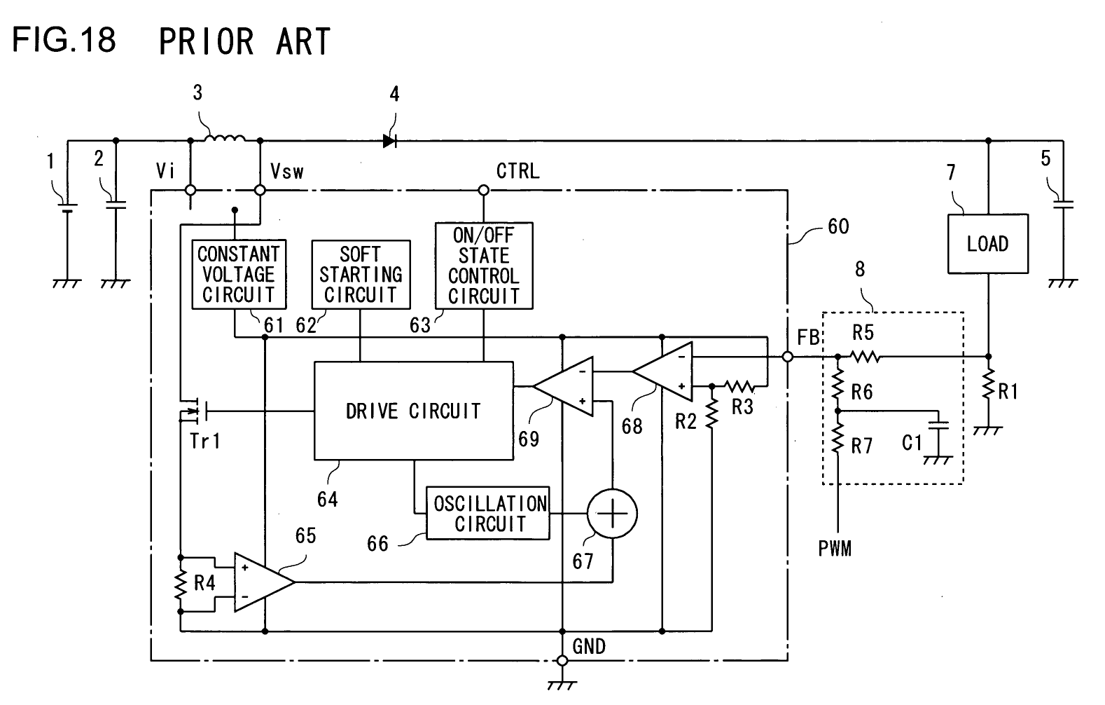

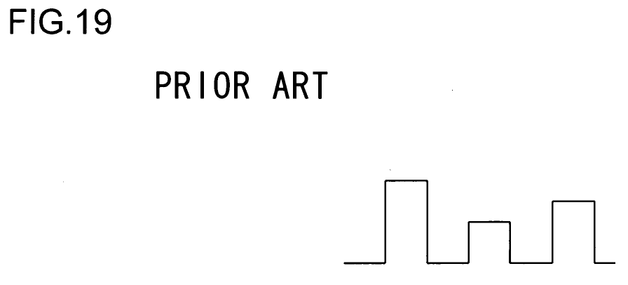

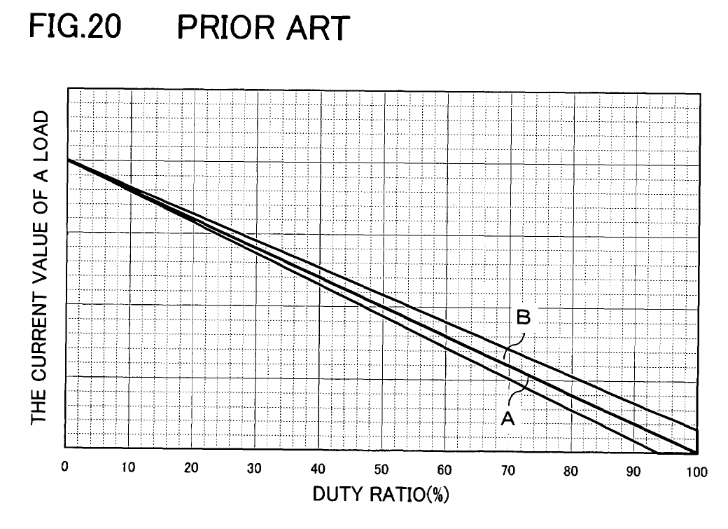

Referring now to the drawings, a first embodiment of the present invention will be described hereinafter. FIG. 1 is a block diagram showing the internal configuration of a power supply circuit device in accordance with the present embodiment. In FIG. 1, such portions to be used for the same purposes as used in a conventional power supply circuit device shown in FIG. 18 will be provided with same symbols, and the detailed description thereof will be omitted.

Same as the case with a power supply circuit device shown in FIG. 18, a power supply circuit device shown in FIG. 1 comprises a direct current power source 1, an input capacitor 2, a coil 3, a diode 4, an output capacitor 5, a resistor R1, supplies a stepped-up output voltage to a load 7. The power supply circuit device shown in FIG. 1 further includes a control circuit device 6 that switches over so as to store the energy in the coil 3 or discharge the energy from the coil 3. Same as a control circuit device 60 in the power supply circuit device shown in FIG. 18, the control circuit device 6 comprises a power transistor Tr1, resistors R2 through R4, a constant voltage circuit 61, a soft starting circuit 62, an ON/OFF state control circuit 63, a drive circuit 64, a current-detecting comparator 65, an oscillation circuit 66, an adding circuit 67, an error amplifier 68, and a PWM comparator 69.

In addition, being different from the control circuit device 60 shown in FIG. 18, the control circuit device 6 is provided with the resistors R5 through R7 that compose the RC filter 8 and has a capacitor C1 composing the RC filter 8 provided to the outside thereof. Then, the control circuit device 6 is provided with a PWM input terminal PWM to which a PWM signal is inputted from the outside, a capacitor terminal C that is connected to an end of a capacitor C1 having the other end thereof grounded, an output voltage input terminal Vo to which an output voltage appearing to the cathode of the diode 4 is inputted, an overvoltage protection circuit 70 that performs a protection operation against the overvoltage based on the output voltage being inputted to the output voltage input terminal Vo, and a buffer circuit 71 that has an input side thereof connected to the PWM input terminal PWM.

Moreover, the capacitor terminal C is connected to the node between the resistors R6 and R7; the resistor R5 is connected to a feedback signal input terminal FB that is connected to one end of the resistor R1 having the other end thereof grounded; and the resistor R7 is connected to the output side of the buffer circuit 71. In consequence, same as the power circuit device shown in FIG. 18, the RC filter 8 consists of the resistors R5 through R7 inside the control circuit device 6 and the capacitor C1 outside the control circuit device 6.

Each portion of the power supply circuit device being configured as mentioned herein above will be described in details hereinafter.

### (ON/OFF Control Circuit)

Same as the power supply circuit device shown in FIG. 18, in accordance with the ON/OFF state control signal that is inputted to the control signal input terminal CTRL, the ON/OFF state control circuit 63 controls the ON/OFF state of each block inside the control circuit device 6. To be specific, when an OFF state control signal is supplied to the control signal input terminal CTRL, the soft starting circuit 62 is initialized, and at the same time, the operations of the drive circuit 64 and the oscillation circuit 66 are stopped so as to place the power transistor Tr1 in the OFF state all the time. In addition, the current-detecting comparator 65, the error amplifier 68, the PWM comparator 69 and the resistors R2 and R3 are stopped to supply the voltage to a voltage-dividing circuit. In order to have the ON/OFF state control circuit 63 confirm that an ON state control signal is inputted, the constant voltage circuit 61 operates so that a low consumption current as much as 1 mA is supplied to the ON/OFF state control circuit 63.

On the contrary, when an ON state control signal is supplied to the control signal input terminal CTRL, the soft starting circuit 62, the drive circuit 64 and the oscillation circuit 66 start operation, and a stepping-up operations are performed by switching over the performance between storing of the energy in the coil 3 and discharging of the energy from the coil 3 by the power transistor Tr1. Hereat, the current-detecting comparator 65, the error amplifier 68, the PWM comparator 69 and the resistors R2 and R3 supply the voltage to the voltage-dividing circuit.

### (Soft Starting Circuit)

Same as the power circuit device shown in FIG. 18, when the ON/OFF state control circuit 63 starts the operation of the drive circuit 64 based on an ON state control signal being inputted to the control signal input terminal CTRL, the soft starting circuit 62 changes gradually the output duty being supplied from the drive circuit 64. In consequence, the power transistor Tr1 performs the ON/OFF behavior with the output being supplied from the drive circuit 64 so as to switch over between the storage of the energy in the coil 3 and the discharge of the energy from the coil 3, thereby moderately increasing the output voltage that is supplied to the load 7.

In a case where the output voltage that is supplied to the load 7 is not increased moderately in such a manner as mentioned hereinabove, when the output capacitor 5 is not charged, an excessive charging current will flow from the direct current power source 1 for charging. Therefore, when a battery such as a lithium ion battery and the like serves as the direct current power source 1, a load will rest on the battery, and at the same time, the battery voltage will be reduced due to the excessive charging current, which prevents the battery from being used until the original final voltage of the battery is attained. However, by providing the soft starting circuit 62, the output voltage to be supplied to the load 7 is increased moderately, thereby preventing such a problem as mentioned hereinabove.

### (Overvoltage Protection Circuit)

When the overvoltage protection circuit 70 detects that the output voltage appearing to the cathode of a diode 4 being inputted to the output voltage input terminal Vo exceeds a predetermined overvoltage protection voltage, the overvoltage protection circuit 70 stops the operation of the drive circuit 64. By behaving in such a manner as mentioned hereinabove, it is not only possible to prevent an overvoltage exceeding the predetermined overvoltage protection voltage from being applied to the load 7 and the output capacitor 5 but also possible to prevent the power transistor Tr1 inside the control circuit device 6 from being destroyed.

### (Current-Detecting Comparator)

Same as the power supply circuit device shown in FIG. 18, by amplifying and outputting the voltage to be supplied to both ends of the resistor R4, the current-detecting comparator 65 outputs a voltage signal to the adding circuit 67 in accordance with the amount of an electric current flowing through the coil 3 when the power transistor Tr1 is turned ON by the drive circuit 64. When the power transistor Tr1 is turned ON, a voltage signal in accordance with an electric current flowing through the coil 3 is provided to the adding circuit 67 from the current-detecting comparator 65 in such a manner as mentioned hereinabove. In consequence, an oscillating signal being supplied to the non-inverting input terminal of the PWM comparator 69 from the adding circuit 67 includes a voltage signal in accordance with the electric current flowing through the coil 3, whereby the peak current flowing through the coil 3 can be controlled.

### (Oscillation Circuit and Adding Circuit)

Same as the power supply circuit device shown in FIG. 18, the oscillation circuit 66 not only outputs an oscillating signal serving as a saw-tooth wave signal to the adding circuit 67 but also outputs a clock signal to operate the drive circuit 64. Then, in the adding circuit 67, a voltage signal that is outputted by the above-mentioned current-detecting comparator 65 in accordance with the amount of an electric current flowing through the coil 3 is supplied to the non-inverting input terminal of the PWM comparator 69 after being added to the oscillating signal that is outputted by the oscillation circuit 66. To be specific, when the amount of the electric current flowing through the coil 3 is large, the signal level of the oscillating signal to be supplied to the non-inverting input terminal of the PWM comparator 69 will be high; and when the amount of the electric current flowing through the coil 3 is small, the signal level of the oscillating signal to be supplied to the non-inverting input terminal of the PWM comparator 69 will be low. As a result, the duty ratio of the PWM signal that is outputted by the PWM comparator 69 is changed, thereby controlling the amount of the electric current flowing through the coil 3.

### (Error Amplifier)

In the error amplifier 68, a feedback signal serving as a voltage signal that occurs by having an output current flowing through the load 7 flow across the resistor R1 is inputted to the inverting input terminal by way of the feedback input terminal FB and the resistor R5. Then, the error amplifier 68 differentially amplifies the reference potential Vref, whose voltage is divided by the resistors R2 and R3 so as to be inputted to the non-inverting input terminal, and the signal level of a feedback signal that is inputted to the inverting input terminal. In consequence, where the signal level of a feedback signal is Vfb and the amplitude ratio of the error amplifier 68 is “A,” the signal level of an output signal of the error amplifier 68 will be “A×(Vref−Vfb).” Then, an output signal of the error amplifier 68 that is obtained by differential amplification in such a manner as mentioned hereinabove is supplied to the PWM comparator 69. By the performance of this error amplifier 68, the output current flowing through the load 7 is stabilized to be a current value that is obtained by dividing the reference potential Vref by the resistance value of the resistor R1.

### (PWM Comparator)

Same as the power source circuit device shown in FIG. 18, in the comparator 69, the signal level of an oscillating signal that is inputted to the non-inverting input terminal from the adding circuit 67 is compared with the signal level of an output signal that is inputted to the inverting internal terminal from the error amplifier 68, and the comparison result is outputted to the drive circuit 64 as a PWM signal. To be specific, during a period when the signal level of an output signal that is supplied from the error amplifier 68 is higher than the signal level of the oscillating signal that is supplied from the adding circuit 67, the PWM signal that is supplied by the PWM comparator 69 will take an “L” level. In addition, during a period when the signal level of an output signal that is supplied from the error amplifier 68 is lower than the signal level of an oscillating signal that is supplied from the adding circuit 67, the PWM signal of the PWM comparator 69 will take an “H” level.

### (Drive Circuit and Power Transistor)

When the drive circuit 64 is turned “ON” by the “ON/OFF” state control circuit 63, the drive circuit 64 operates based on a clock signal that is supplied from the oscillation circuit 66. At this time, immediately after the drive circuit 64 is turned “ON” by the “ON/OFF” state control circuit 63, the drive circuit 64 is controlled by the soft starting circuit 62, thereby making the duty ratio small; and as a result, the period in which the voltage to be supplied to the gate of the power transistor Tr1 is set at an “H” level is specified to be short. Then, the drive circuit 64 is controlled by the soft starting circuit 62 so as to gradually increase the duty ratio, which extends the period in which the voltage to be supplied to the gate of the power transistor Tr1 is set at the “H” level, whereby the output voltage Vout to be supplied to the load 7 is gradually increased.

In addition, when the soft starting that is performed by the soft starting circuit 62 is completed and the operation is switched over to a normal operation, the drive circuit 64 operates based on a PWM signal that is outputted from the PWM comparator 69. When the PWM signal of the PWM comparator 69 takes an “H” level, the power transistor Tr1 is turned “OFF” by supplying the gate of the power transistor Tr1 with a voltage signal taking an “L” level. As a result, the energy that is stored in the coil 3 is discharged to the output side by way of the diode 4. On the contrary, when the PWM signal of the PWM comparator 69 takes an “L” level, the power transistor Tr1 is turned “ON” by supplying the gate of the power transistor Tr1 with a voltage signal taking an “H” level in accordance with a clock signal that is outputted from the oscillation circuit 66. As a result, the energy from the direct current power source 1 is stored in the coil 3.

By performing in such a manner as mentioned hereinabove, a rectifying operation is performed by the diode 4 and the capacitor 5, whereby an output voltage Vout that is stepped up is supplied to the load 7; wherein, the output current flowing to the load 7 is determined by the duty ratio of a PWM signal that is supplied from the PWM comparator 69. To be specific, when the duty ratio of the PWM signal of the PWM comparator 69 is high, the value of an electric current flowing to the load 7 will be decreased, and when the duty ratio of the PWM signal of the PWM comparator 69 is low, the value of the electric current flowing to the load 7 will be increased.

### (Constant Voltage Circuit)

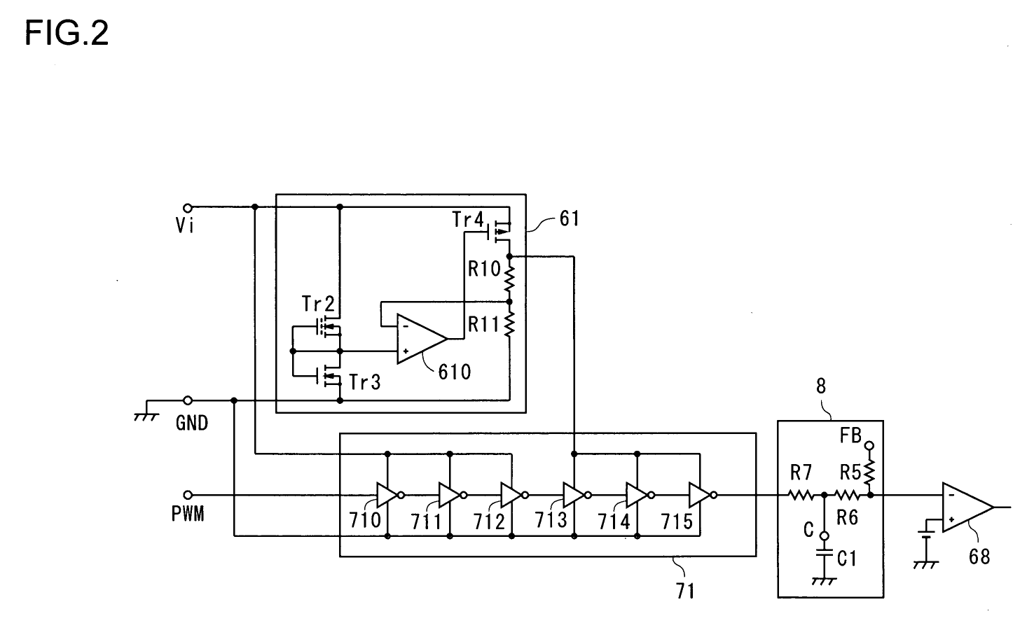

Same as the power source circuit device shown in FIG. 18, a constant voltage circuit 61 is connected to a positive electrode of the direct current power source 1 by way of the input voltage input terminal Vi and grounded through the ground terminal GND, whereby the direct current voltage of the direct current power source 1 is applied thereto. Then, based on the direct voltage of the direct current power source 1, a stable constant voltage is generated so as to be supplied to each circuit component inside the power source circuit device. The configuration of the constant voltage circuit 61 will be described by referring to a circuit diagram shown in FIG. 2. The circuit diagram shown in FIG. 2 is a circuit diagram showing the configuration of a constant voltage circuit 61, a buffer circuit 71 and an RC filter 8.

As shown in FIG. 2, the constant voltage circuit 61 comprises a transistor Tr2 that is a depression type of N-channel metal-oxide-semiconductor field effect transistor that has a drain thereof connected to the input voltage input terminal Vi and has a gate and a source thereof connected each other; a transistor Tr3 that is an enhancement type of N-channel metal-oxide-semiconductor field effect transistor that has a source thereof connected to the ground terminal GND and has a gate and a drain thereof connected to the gate and the source of the transistor Tr2; a differential amplifier 610 in which a reference voltage appearing to a node between the source of the transistor Tr2 and the drain of the transistor Tr3 is inputted to a non-inverting input terminal; a transistor Tr4 that is a P-channel metal-oxide-semiconductor field effect transistor in which an output from the differential amplifier 610 is inputted to the gate; a resistor R10 that has one end thereof connected to the drain of the transistor Tr4; and a resistor R11 that has one end thereof connected to the other end of the resistor R10 and has the other end thereof connected to the ground terminal GND. Then, the node between the resistors R10 and R11 is connected to the inverting input terminal of the differential amplifier 610, and at the same time, the source of the transistor Tr4 is connected to the input voltage input terminal Vi.

Being constructed as described hereinabove, the transistors Tr2 and Tr3 serve as a resistance. Therefore, by the resistance values of the transistors Tr2 and Tr3, an input voltage Vin that is supplied from the direct current power source 1 is divided, and consequently, a reference potential Vref appears to the node between the transistors Tr2 and Tr3, so as to be supplied to the non-inverting input terminal of the differential amplifier 610. In addition, an electric current flowing to the transistor Tr4 based on the output from the differential amplifier 610 is controlled, whereby a constant potential Vs appears to the drain of the transistor Tr4, so as to be supplied to each circuit component inside the control circuit device 6.

At this time, since the voltage that appears by having the transistor Tr4 controlled is divided by the resistors R10 and R11 and is inputted to the inverting terminal of the differential amplifier 610, a negative feedback circuit is formed. And in consequence, an output voltage that is supplied to the gate of the transistor Tr4 from the differential amplifier 610 is set in a manner that a potential appearing by having a voltage divided by the resistors R10 and R11 comes close to a reference potential Vref. In addition, where the resistance values of the resistors R10 and R11 are r10 and r11, respectively, the referential potential Vref1 is “r11×Vs/(r10+r11).” By having such a configuration of the negative feedback circuit as mentioned hereinabove, a constant potential Vs is supplied to each circuit component inside the control circuit device 6 serving as an internal constant voltage.

Furthermore, as described hereinabove, in order to make the transistor Tr2 be a depression type and the transistor Tr3 be an enhancement type, by adjusting the aspect ratios thereof, the temperature characteristic of an internal constant voltage that is outputted from the transistor Tr4 can be adjusted, and at the same time, temperature-dependent properties are provided. The resistors R5 through R7 of the RC filter 8 that will be described hereinafter are installed to the internal of the control circuit device 6 and provided with the temperature-dependent properties. (The temperature-dependent properties are provided in the negative direction when a high polysilicon resistance is employed, while the temperature-dependent properties are provided in the positive direction when a diffusion resistance is employed.) However, by providing an output voltage that is supplied from the constant voltage circuit 61 with the temperature-dependent properties in such a manner as described hereinabove, the temperature-dependent properties of the RC filter 8 are deleted.

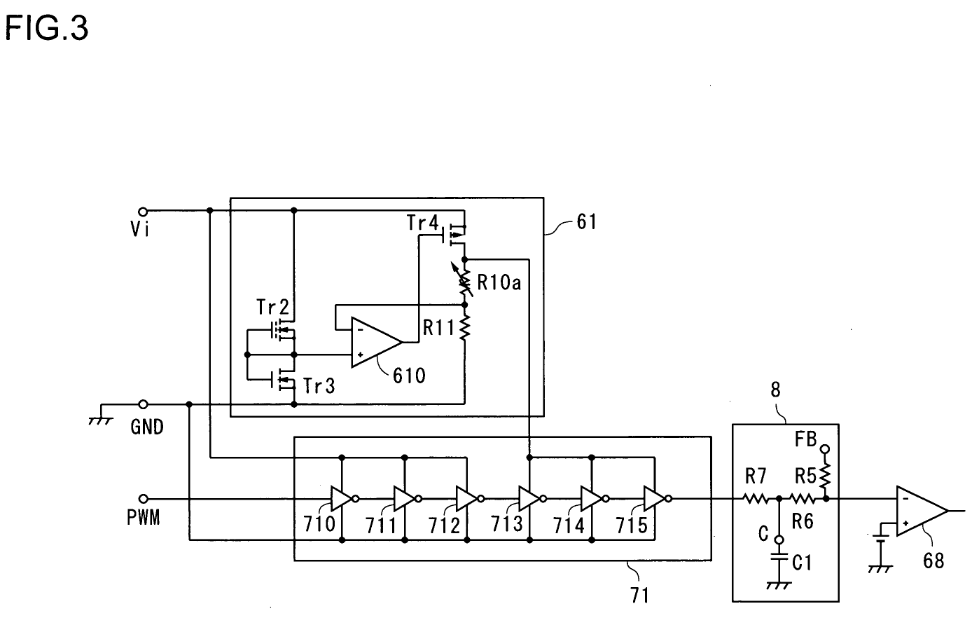

The constant voltage circuit 61 is configured in such a manner as one for each of the depression type and the enhancement type of metal-oxide-semiconductor field effect transistors is connected in series, respectively, like the transistors Tr2 and Tr3 so as to specify the reference potential Vref1 that is supplied to the differential amplifier 610. However, a plurality of the depression type and the enhancement type of metal-oxide-semiconductor field effect transistors may be connected in series so as to specify the reference potential Vref1 that is supplied to the differential amplifier 610. In addition, as shown in FIG. 3, by providing a variable resistor R10a instead of the resistor R10 shown in FIG. 2, a potential appearing to the drain of the transistor Tr4 may be trimmed by switching over the resistance value of the variable resistor R10. By being configured in such a manner as mentioned hereinabove, more stable internal constant voltage can be provided, and such a linear relationship between the current value of the load 7 and the duty ratio of a PWM signal being supplied from the outside that will be described hereinafter can be obtained as has a little variation.

### (Buffer Circuit and RC Filter)

The RC filter 8 has a same configuration as the power source circuit device shown in FIG. 18, comprising the resistors R5 through R7 inside the control circuit device 6 and a capacitor C1 outside the control circuit device 6. To be specific, as shown in the circuit diagram in FIG. 2, the RC filter 8 comprises a resistor R5 that has one end thereof connected to the feedback signal input terminal FB and has the other end thereof connected to an inverting input terminal of the error amplifier 68; a resistor R6 that has one end thereof connected to the other end of the resistor R5; a resistor R7 that has one end thereof connected to the other end of the resistor R6 and has the other end thereof connected to the output side of the buffer circuit 71; and a capacitor C1 that has one end thereof connected to the node between the resistors R6 and R7 by way of a capacitor terminal C and has the other end thereof grounded.

To be specific, a PWM signal that is inputted to one end of the resistor R7 by way of the buffer circuit 71 passes through a filter consisting of the resistors R6 and R7 and the capacitor C1, whereby a potential is provided to the node between the resistors R5 and R6 in accordance with the signal level of a PWM signal. Additionally, a potential is provided to the node between the resistors R5 and R6 by way of the feedback signal input terminal FB and the resistor R5 in accordance with the signal level of a feedback signal appearing to the resistor R1. In consequence, such a potential appears to the node between the resistors R5 and R6 as has the signal level of the feedback signal added to the signal level of the PWM signal. To be specific, the inverting input terminal of the error amplifier 68 receives a potential that is equal to a value that is obtained by having a PWM signal being supplied from the outside added to a feedback signal.

The buffer circuit 71 comprises three inverters 710 through 712 to which a voltage Vin being supplied from the direct current power source 1 is applied by being connected to the input voltage input terminal Vi and the grounding terminal GND; and three inverters 713 through 715 to which an internal constant voltage Vs is applied by being connected to the drain of the transistor Tr4 and the grounding terminal GND. In the buffer circuit 71 that is configured as described hereinabove, the input side of the inverter 710 is connected to the PWM input terminal PWN, while the output side of the inverter 715 is connected to the other end of the resistor R7. In addition, these six inverters 710 through 715 are connected in series in such a sequence as 710, 711, 712, 713, 714 and 715.

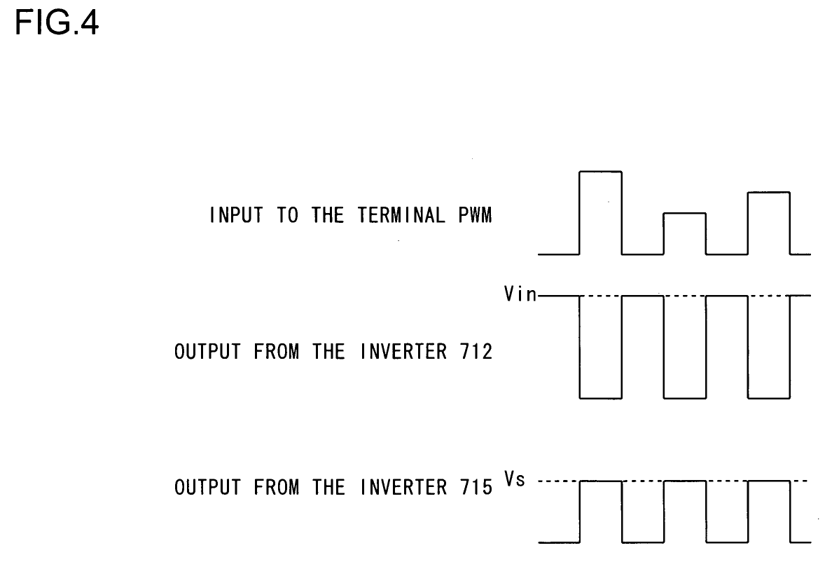

The time transient of the signal level at each portion of the buffer circuit 71 being configured as described hereinabove is shown in the timing chart of FIG. 4. To be specific, as shown in FIG. 4, when a PWM signal that has a variation in the signal level thereof being at an “H” level is inputted, the PWM signal is transformed to obtain a waveform in accordance with the voltage Vin, being supplied from the direct current power source 1, by the inverters 710 through 712 that have the voltage Vin serve as a bias voltage. Then, a PWM signal that is transformed to obtain a waveform in accordance with the voltage Vin is outputted from the inverter 712 so as to be inputted to the inverter 713. Therefore, the PWM signal to be inputted to the inverter 713 will be influenced by a change in the voltage Vin. In addition, a PWM signal to be inputted to the inverter 713 will be a signal that is inverted from the PWM signal having been inputted to the PWM input terminal PWM.

Moreover, when a PWM signal being transformed to obtain a waveform in accordance with the voltage Vin is inputted to the inverter 713, the PWM signal is transformed by the inverters 713 through 715 to obtain a waveform in accordance with the voltage Vs being supplied from the constant voltage circuit 61. Because the voltage Vs is controlled to be constant in the constant voltage circuit 61, the “H” level of the PWM signal being outputted from the inverter 715 becomes constant at the constant voltage Vs. In addition, because the PWM signal that is outputted from the inverter 715 is an inverted signal from the PWM signal that is inputted to the inverter 713, the PWM signal that is outputted from the inverter 715 has the same polarity as the PWM signal that is inputted to the PWM input terminal PWM. In consequence, not only a variation in the signal level being at an “H” level before being inputted to the PWM input terminal PWM can be removed from the PWM signal that is supplied to the resistor R7 of the RC filter 8, but also an influence of a change in the voltage Vin being supplied from the direct current power source 1 is not provided.

As mentioned hereinabove, not only the variation that exists before being supplied with an input from the outside is got rid of by the buffer circuit 71, but also the CR filter 8 is provided with a PWM signal that does not receive any influence of an input voltage Vin being supplied from the direct current power source 1. Then, as shown in FIG. 4, in the CR filter 8, a voltage signal in which a PWM signal being determined by the constant voltage Vs is overlapped over a feedback signal being inputted to the feedback input terminal FB is outputted to the error amplifier 68.

By configuring and operating each portion as described hereinabove, the error amplifier 68 supplies the PWM comparator 69 with a voltage signal that represents a difference between a voltage value of a feedback signal that appears to the resistor R1 and is inputted to the inverting input terminal of the error amplifier 68 by way of the resistor R5 and the reference voltage Vref that is obtained by having the voltages divided in the resistors R2 and R3. Then, the PWM comparator 69 compares the signal level of a voltage signal that serves as a difference signal being obtained by the error amplifier 68 with the signal level of an oscillating signal being supplied from the adding circuit 67, whereby, the drive circuit 64 receives a PWM signal having a low duty ratio from the PWM comparator 69 when the difference between the voltage value of the feedback signal and the reference voltage Vref is large; and when the difference between the voltage value of the feedback signal and the reference voltage Vref is small, the drive circuit 64 receives a PWM signal having a high duty ratio from the PWM comparator 69. Then, the load 7 is provided with an output current that is specified by the resistance values of the reference voltage Vref and the resistor R1.

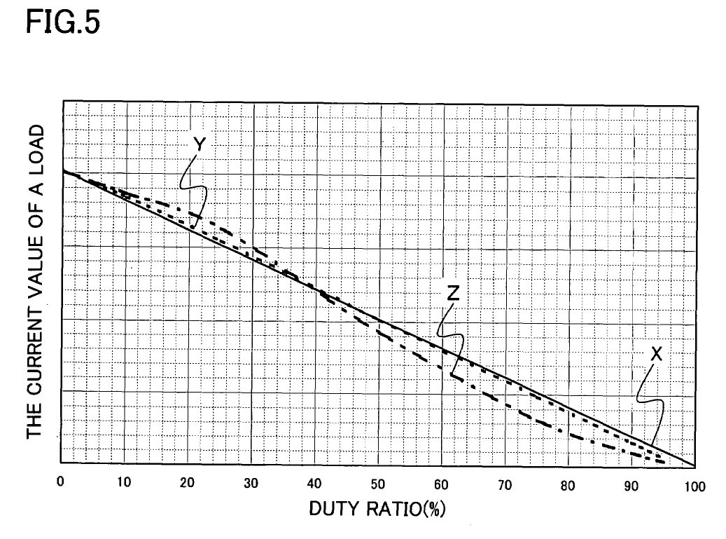

Hereat, a PWM signal is supplied to the control circuit device 6 from the outside. Therefore, when the signal level of a PWM signal being supplied from the outside takes an “H” level, the difference from the reference voltage Vref becomes small, whereby the output signal of the error amplifier 68 is decreased. As a result, when a period during which the PWM signal being supplied from the outside takes an “H” level becomes long, the period during which the output signal being supplied from the error amplifier 68 is small becomes long. In consequence, the duty ratio of the PWM signal that is supplied from the PWM comparator 69 becomes high, which reduces the value of the electric current flowing to the load 7. To be specific, in a graph in FIG. 5 showing the relationship between the current value of the load 7 and the duty ratio of the PWM signal being supplied from the outside, when an ideal relationship being indicated in a solid line is achieved, it is possible to control the current value of the load 7 to become small by increasing the duty ratio of the PWM signal being supplied from the outside.

As described hereinabove, with the construction in accordance with the present embodiment, a variation in a PWM signal that is supplied from the outside can be got rid of by providing a buffer circuit 71, so that a PWM signal taking an “H” level of the voltage that is constant is inputted to the RC filter 8. In consequence, the relationship between the current value of the load 7 and the duty ratio of the PWM signal being supplied from the outside can be made to approach to the solid line “X” showing an ideal relationship shown in FIG. 5. In addition, the configuration of the buffer circuit 71 is not limited to the configuration that is shown in the circuit diagram in FIG. 2, but may have such a circuit configuration as can perform transformation into a waveform by utilizing a constant voltage that is generated in the constant voltage circuit 61 and the like.

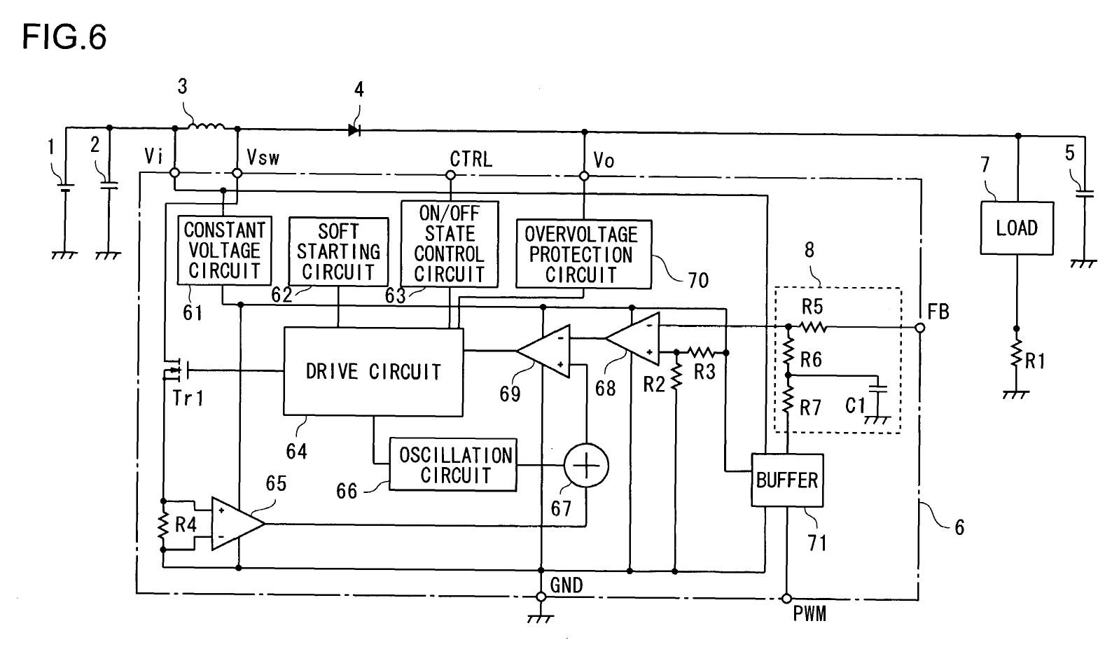

When a capacitor C1 is installed outside of the control circuit device 6 in such a manner as is in accordance with the present embodiment, by specifying the capacitor C1 to be approximately as much as 0.1° F., the relationship between the current value of the load 7 and the duty ratio of a PWM signal being supplied from the outside comes to obtain such a relationship as is indicated in a dotted line “Y” shown in FIG. 5. In addition, as shown in FIG. 6, when the capacitor C1 is installed inside the control circuit device 6, by specifying the capacitor C1 to be approximately as much as 20 pF, the relationship between the current value of the load 7 and the duty ratio of a PWM signal being supplied from the outside comes to obtain such a relationship as indicated in a dashed-dotted line “Z” shown in FIG. 5. As a result, the relationship between the current value of the actual load 7 and the duty ratio of a PWM signal being supplied from the outside can be made to be close to the ideal relationship as described hereinabove.

### Second Embodiment

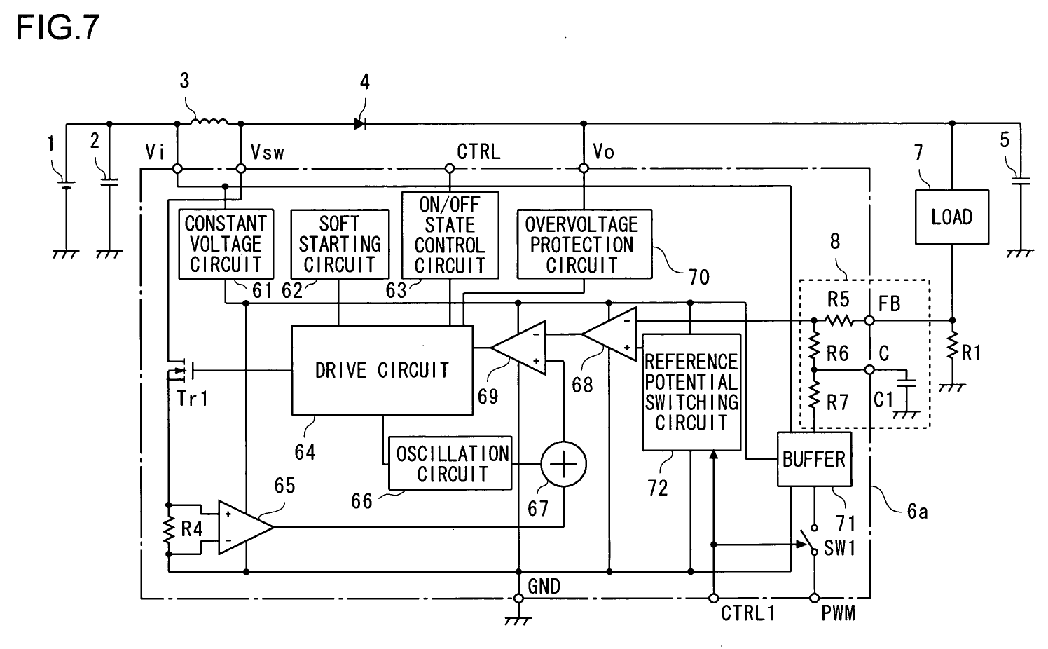

Referring now to the drawings, a second embodiment of the present invention will be described hereinafter. FIG. 7 is a block diagram showing the internal configuration of a power supply circuit device in accordance with the present embodiment. In FIG. 7, such portions to be used for the same purposes as used in a power supply circuit device shown in FIG. 1 will be provided with same symbols, and the detailed description thereof will be omitted.

As shown in FIG. 7, in a power source circuit device in accordance with the present embodiment, the configuration of a control circuit device 6 of a power source circuit device in accordance with the first embodiment (See FIG. 1.) is changed. To be specific, the control circuit device 6a inside the power source circuit device shown in FIG. 7 is provided with a reference potential switching circuit 72 that can switch over a reference potential, instead of a voltage dividing circuit consisting of the resistors R2 and R3 in the control circuit device 6 (See FIG. 1.); and a control signal input terminal CTRL1 into which a switching control signal is inputted for switching over a reference potential that is supplied from the reference potential switching circuit 72. Moreover, the control circuit device 6a is provided with a switch SW1 that is connected between the PWM input terminal PWM and the buffer circuit 71.

With such configuration as mentioned hereinabove, a reference potential to be supplied to the non-inverting input terminal of the error amplifier 68 is switched over by changing a reference potential that is supplied from the reference potential switching circuit 72. Therefore, when the value of an electric current to the load 7 is reduced, the switch SW1 is turned OFF, so that the control of the electric current to the load 7 by an external PWM signal being inputted to the PWM input terminal PWM from the outside will be stopped, and instead, the control of the electric current to the load 7 is started based on a reference potential that is supplied from the reference potential switching circuit 72. In addition, since the control operation of an electric current to the load 7 by a PWM signal that is supplied to the PWM input terminal PWM from the outside is the same as that of the first embodiment, the control operation of the electric current to the load 7 based on a reference potential that is supplied from the reference potential switching circuit 72 will be described hereinafter.

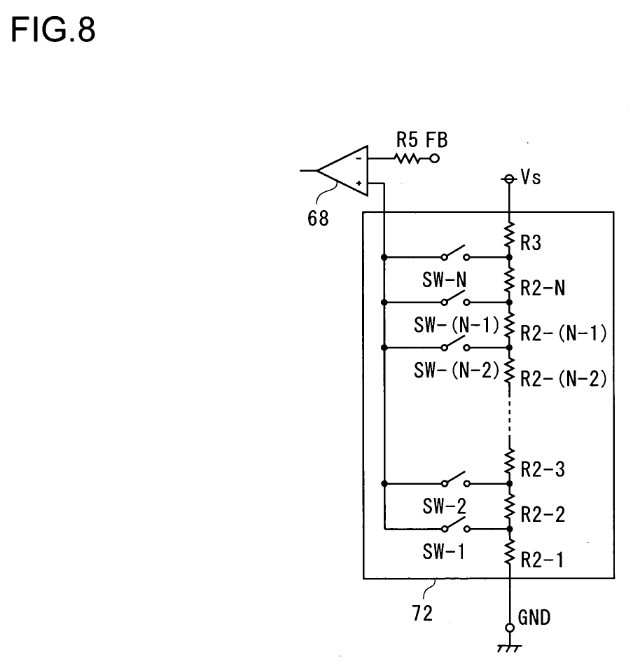

First of all, the configuration of the reference potential switching circuit 72 will be described by referring to the circuit diagram in FIG. 8. As shown in FIG. 8, the reference potential switching circuit 72 comprises a resistor R3 that has one end thereof supplied with an output potential being outputted from the constant voltage circuit 61; “N” pieces of resistors R2-1 through R2-N that are connected in series between the other end of the resistor R3 and the grounding terminal GND; and “N” pieces of switches SW-1 through SW-N that have each one end thereof connected to each node between the resistors R2-1 through R2-N and the resistor R3, respectively, and have each other end thereof connected to the non-inverting input terminal of the error amplifier 68.

Hereat, the switch SW-n (The character “n” represents an integer of “1≦n<N.”) is connected to a node between the resistor R2-n and the R2-(n+1), and the switch SW-N is also connected to a node between the resistor R2-N and the resistor R3. In consequence, the switches SW-1 through SW-N are connected to the non-inverting input terminal of the error amplifier 68 in parallel, and when one of the switches SW-1 through SW-N is turned ON, a potentials appearing to the nodes between the resistors R2-1 through R2-N and the resistor R3, respectively, are selected so as to be inputted to the non-inverting input terminal of the error amplifier 68.

In the reference potential switching circuit 72 as described hereinabove, the resistor R2-1 is connected to the grounding terminal GND, and then connected in series to the resistors R2-2, R2-3 up to R2-N sequentially. Wherein, a reference voltage that is supplied to the non-inverting input terminal of the error amplifier 68, having one of the switches SW-1 through SW-N turned ON, is increased in such a sequence as the switches SW-1, SW-2 up to SW-N. Then, the ON/OFF state of the switches SW-1 through SW-N being housed in the reference potential switching circuit 72 is controlled by a switching control signal that is inputted to the control signal input terminal CTRL1. In addition, the ON/OFF state of the switch SW1 is also controlled by this switching control signal.

Consequently, when an output current to the load 7 is minimal, the ON/OFF state of the switches SW-1 through SW-N of the reference potential switching circuit 72 is controlled by a switching control signal, a resistance value of the reference potential switching circuit 72 will be changed and the switch SW1 will be turned OFF, thereby forbidding inputting of a PWM signal to the buffer circuit 71 from the PWM input terminal PWM. In addition, when the switch SW1 is turned ON to input a PWM signal being supplied from the outside to the buffer circuit 71, thereby controlling the output current to the load 7 by the duty ratio of the PWM signal being supplied from the outside, the switch SW-N is turned ON and a reference potential Vref appearing to a node between the resistor R2-N and the resistor R3 is inputted to the non-inverting input terminal of the error amplifier 68.

In a case where the output current to the load 7 is controlled by switching over the reference potential being supplied from the reference potential switching circuit 72, when the switch SW-n is selected and turned ON, a potential being “rn/rN×Vref” is inputted to the non-inverting input terminal of the error amplifier 68 by a resistance value “rn” that is obtained by adding the resistance values of the resistors R2-1 through R2-n being connected in series, and a resistance value “rN” that is obtained by adding the resistance values of the resistors R2-1 through R2-N being connected in series. To be specific, when the value “n” of the selected switch SW-n is small, the potential to be supplied to the non-inverting input terminal of the error amplifier 68 will become small, whereby the output current to the load 7 is controlled so as to be small.

When such behaviors as mentioned hereinabove are performed, the ON-OFF state of each of the switches SW-1 through SW-N may be controlled by the value of each digit of a switching control signal, having a switching control signal serve as a signal having an “N” bit. To be specific, the ON/OFF state of the switch SW-n is controlled by the value of the “n” digit (the number of the “nth” bit) of the switching control signal. At this time, in addition to the switch SW-N, the ON/OFF state of the switch SW1 is also controlled by the value of the number of the “Nth” bit. Additionally, by making a switching control signal have a smaller number of bits than the “N” bit, and also by installing a decoder for converting the switching control signal into a signal having “N” bits, a signal being supplied from the decoder may be provided to the switches SW-1 through SW-N and the switch SW1.

### Third Embodiment

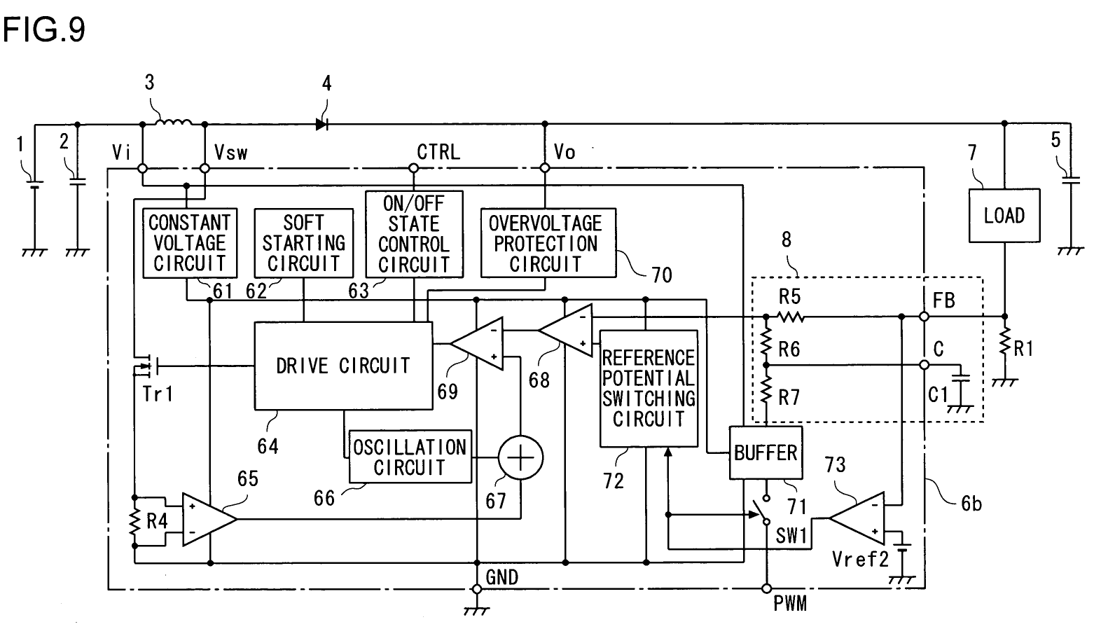

Referring now to the drawings, a third embodiment of the present invention will be described hereinafter. FIG. 9 is a block diagram showing the internal configuration of a power supply circuit device in accordance with the present embodiment. In FIG. 9, such portions to be used for the same purposes as used in a conventional power supply circuit device shown in FIG. 7 will be provided with same symbols, and the detailed description thereof will be omitted.

Being different from a control circuit device 6a in the power source circuit device in accordance with the second embodiment (See FIG. 7.), a control circuit device 6b in the power supply circuit device in accordance with the present embodiment automatically performs the ON/OFF state control of the switch SW1 as well as switching control of a reference potential that is supplied from the reference potential switching circuit 72. As shown in FIG. 9, against the configuration of the control circuit device 6a shown in FIG. 7, the control circuit device 6b is provided with a comparator 73, wherein an inverting input terminal is connected to a feedback signal input terminal FB and a reference potential Vref2 is inputted to the non-inverting input terminal, wherein the switch SW1 and the reference potential switching circuit 72 are controlled by the output of the comparator 73. Then, since the control is carried out without having a switching control signal inputted, the control signal input terminal CTRL1 is omitted. In addition, same as in accordance with the second embodiment, the reference potential switching circuit 72 has a configuration that is shown in FIG. 8.

With such a configuration as described hereinabove, when the electric current to the load 7 is large, the signal level of a feedback signal is higher than a reference potential Vref2, and the output of the comparator 73 is positive, the switch SW1 and the switch SW-N are turned ON, while the switches SW-1 through SW-(N−1) are turned OFF. In consequence, when the output current to the load 7 is large, the value of the output current to the load 7 is controlled by a PWM signal that is supplied from the outside.

In a case where the output of the comparator 73 is negative when the signal level of a feedback signal is lower than the reference potential Vref2, first, the switch SW1 is turned OFF. Then, by having only one switch selected to be turned ON among the switches SW-1 through SW-N in accordance with a degree of a difference, appearing from an output of the comparator 73, between the signal level of the feedback signal and the reference potential Vref2, a reference potential being outputted from the reference potential switching circuit 72 is switched over. To be specific, when the value of the signal level of a feedback signal becomes low, one switch is selected to be turned ON among the switches SW-1 through SW-N so that the reference potential being supplied from the reference potential switching circuit 72 will be come low.

With such a configuration as described hereinabove, when the value of a signal being outputted from the comparator 73 is negative, the ON/OFF state of the switches SW-1 through SW-N may be controlled in accordance with the value of each digit by converting the signal being outputted from the comparator 73 into a digital signal having “N” bits. In addition, same as in accordance with the second embodiment, by having a control signal input terminal CTRL1 provided so as to receive a switching control signal, a reference potential being outputted from the reference potential switching circuit 72 may be controlled.

### Fourth Embodiment

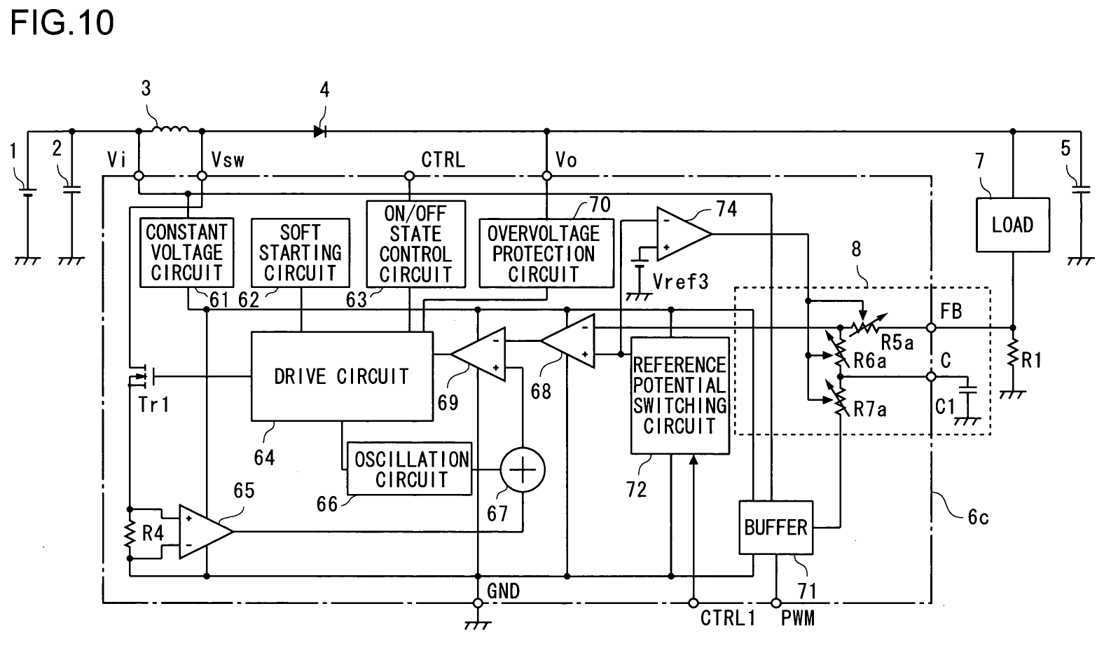

Referring now to the drawings, a fourth embodiment of the present invention will be described hereinafter. FIG. 10 is a block diagram showing the internal configuration of a power supply circuit device in accordance with the present embodiment. In FIG. 10, such portions to be used for the same purposes as used in a conventional power supply circuit device shown in FIG. 7 will be provided with same symbols, and the detailed description thereof will be omitted.

Being different from the control circuit device 6a in the power source circuit device in accordance with the second embodiment (See FIG. 7.), a control circuit device 6c in the power supply circuit device in accordance with the present embodiment switches over the resistance value of the RC filter 8 in accordance with the value of a reference potential being supplied from the reference potential switching circuit 72. As shown in FIG. 10, against the configuration of the control circuit device 6a shown in FIG. 7, the control circuit device 6c is provided with variable resistors R5a through R7a that can switch over the resistance value instead of the resistors R5 through R7; and is also provided with a comparator 74 to which not only a reference potential is inputted to the inverting input terminal from the reference potential switching circuit 72 but also a reference potential Vref3 is inputted to the non-inverting input terminal. Additionally, the switch SW1 is omitted. Then, by the output of the comparator 74, the resistance values of the variable resistors R5a through R7a composing the RC filter 8 are switched over. Moreover, same as in accordance with the second embodiment, the reference potential switching circuit 72 has a configuration that is shown in FIG. 8.

With such a configuration as described hereinabove, same as the power source circuit device in accordance with the second embodiment, a reference potential being supplied from the reference potential switching circuit 72 is switched over based on a switching control signal that is inputted to the control signal input terminal CTRL1. Then, when the reference potential being supplied from the reference potential switching circuit 72 is specified to become low in order to decrease the output current to the load 7, the resistance values of the variable resistors R5a through R7a are switched over by the output of the comparator 74.

Hereat, the resistance values of the variable resistors R5a through R7a are changed in a manner that the signal level of a PWM signal to be inputted to the RC filter 8 from the buffer circuit 71 will become small in accordance with the signal level of a feedback signal that is inputted to the feedback signal input terminal FB. In consequence, the signal level of a signal that is obtained by adding a feedback signal and a PWM signal and is to be inputted to the inverting input terminal of the error amplifier 68 from the RC filter 8 will take a signal level corresponding to the reference potential that is supplied from the reference potential switching circuit 72. And thereby, it is possible to control the output current to the load 7 even in a case where the output current to the load 7 is minimal.

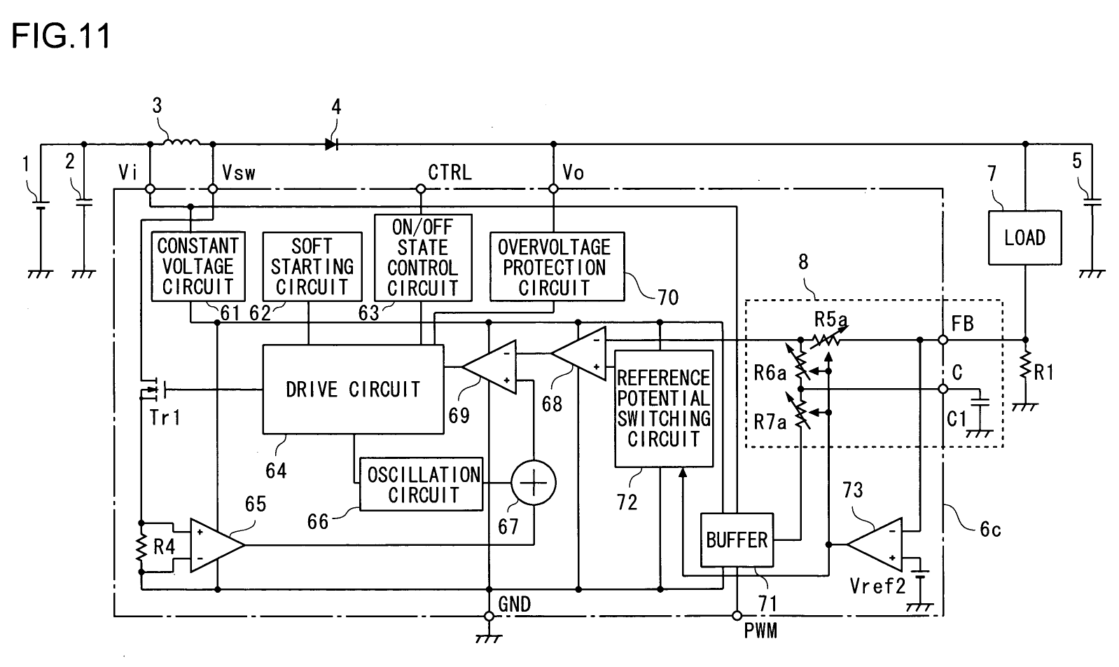

In addition, in accordance with the present embodiment, the resistance values of the variable resistors R5a through R7a that construct the RC filter 8 can be switched over by the output of the comparator 74. However, the resistance values of the variable resistors R5a through R7a may be switched over by a switching control signal. Moreover, same as the power source circuit device in accordance with the third embodiment, as shown in FIG. 11, a power source circuit device may be provided with a comparator 73 that has an inverting input terminal thereof connected to the feedback signal input terminal FB, wherein the reference potential being supplied from the reference potential switching circuit 72 and the resistance values of the resistors R5a through R7a may be switched over by the output of the comparator 73.

In accordance with the second through the fourth embodiments, as an index for switching over the control of the output current to the load 7 from the control being performed by the duty ratio of a PWM signal being supplied from the outside to the control being performed by a reference potential being supplied from the reference potential switching circuit 72, it is good to switch cover the control of the output current to the load 7 when the duty ratio of a PWM signal being supplied from the outside is 80 to 90%. When the duty ratio of a PWM signal being supplied from the outside becomes 80 to 90% as described hereinabove, the control performance can be achieved more effectively by making it possible to control the output current to the load 7 by a reference potential being supplied from the reference potential switching circuit 72. In addition, in accordance with the second through the fourth embodiments, the reference potential switching circuit 72 has such a configuration as shown in a circuit diagram shown in FIG. 8. However, by making the resistors R2 and R3 composing a voltage-dividing circuit shown in FIG. 1 serve as variable resistors so as to switch over the resistance values thereof, the reference potential may be switched over.

### Fifth Embodiment

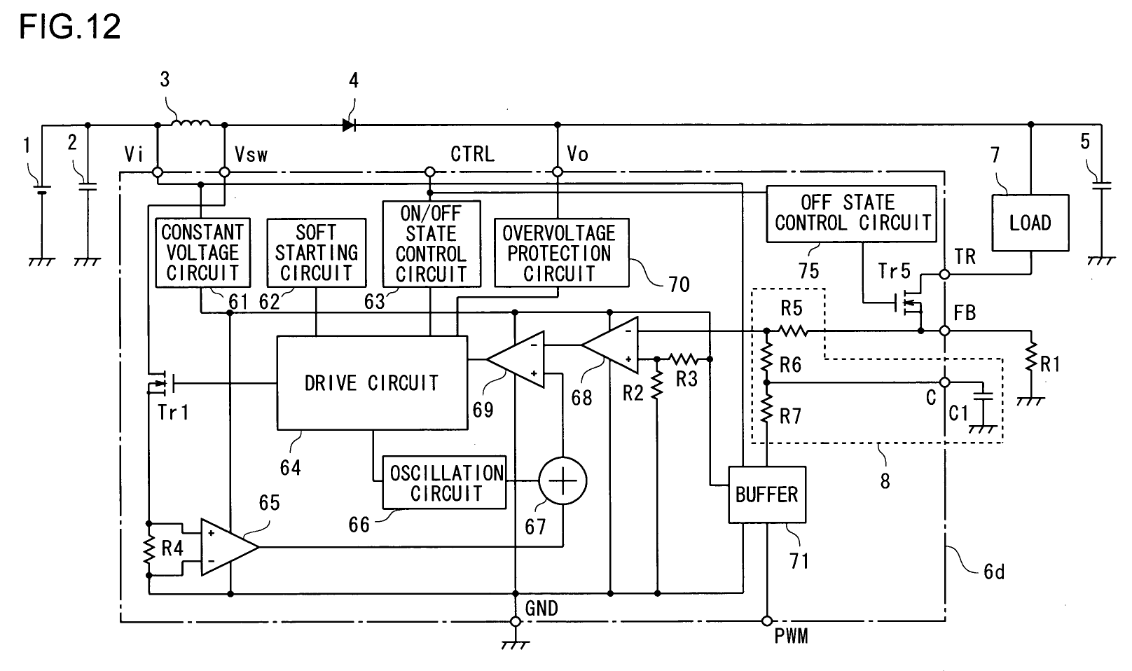

Referring now to the drawings, a fifth embodiment of the present invention will be described hereinafter. FIG. 12 is a block diagram showing the internal configuration of a power supply circuit device in accordance with the present embodiment. In FIG. 12, such portions to be used for the same purposes as used in a conventional power supply circuit device shown in FIG. 1 will be provided with same symbols, and the detailed description thereof will be omitted.

As shown in FIG. 12, the power source circuit device in accordance with the present embodiment has a control circuit device 6d whose configuration is changed from the configuration of a control circuit device 6 in the power source circuit device in accordance with the first embodiment (See FIG. 1.). To be specific, in addition to the configuration of the control circuit device 6, the control circuit device 6d in the power source circuit device as shown in FIG. 12 includes a transistor Tr5 serving as an N-channel metal-oxide-semiconductor field effect transistor that is connected between the load 7 and the resistor R1; an OFF state control circuit 75 that supplies a signal to the gate of the transistor Tr5; and a terminal TR that is installed between the load 7 and the drain of the transistor Tr5. Additionally, the source of the transistor Tr5 is connected to the resistor R1 by way of the feedback signal input terminal FB. Moreover, the OFF state control circuit 75 receives an ON/OFF state control signal that is inputted therein from the control signal input terminal CTRL.

In the power supply circuit device being provided with such a configuration as described hereinabove and with the control circuit device 6d, when an ON state control signal is inputted therein from the control signal input terminal CTRL, the transistor Tr5 is controlled to be turned ON by the OFF state control circuit 75. At this time, the operation is performed in the same manner as the power source circuit device being provided with a control circuit device 6 in accordance with the first embodiment, and the amount of the output current to the load 7 is controlled based on a PWM signal that is supplied from the outside. Therefore, the description about the operation when the ON state control signal is inputted will be omitted but will be referred to the description of the first embodiment.

To the contrary, when an OFF state control signal is inputted from the control signal input terminal CTRL, the transistor Tr5 is controlled to be turned OFF by the OFF state control circuit 75. As described hereinabove, since the transistor Tr5 is turned OFF, the electrical connection between the load 7 and the grounding potential is cut off. In consequence, the electric current can be prevented from leaking to the load 7 when the power source circuit device is turned OFF, whereby the consumption of the electric power to the load 7 can be restrained when the power source circuit device is turned OFF. In addition, same as the control circuit device 6 in the power source circuit device in accordance with the first embodiment, the soft starting circuit 62 is initialized, and at the same time, by stopping operations of the drive circuit 64 and the oscillation circuit 66, the power transistor Tr1 is always placed in the OFF state.

### Sixth Embodiment

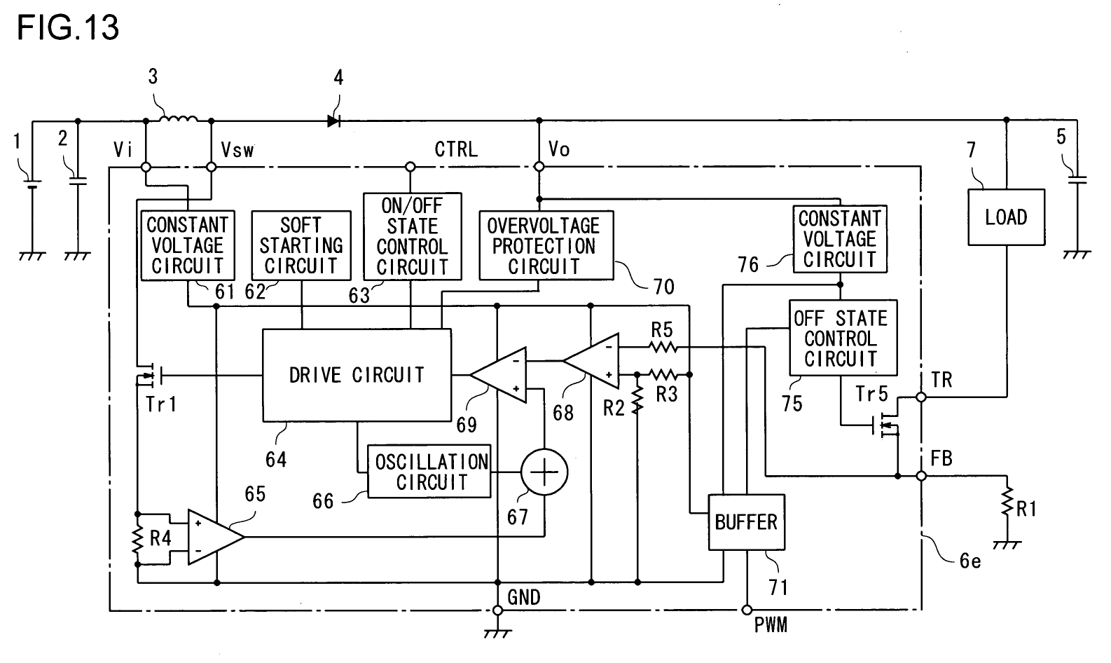

Referring now to the drawings, a sixth embodiment of the present invention will be described hereinafter. FIG. 13 is a block diagram showing the internal configuration of a power supply circuit device in accordance with the present embodiment. In FIG. 13, such portions to be used for the same purposes as used in a conventional power supply circuit device shown in FIG. 12 will be provided with same symbols, and the detailed description thereof will be omitted.

As shown in FIG. 13, the power source circuit device in accordance with the present embodiment has a control circuit device 6e whose configuration is changed from the configuration of the control circuit device 6d in the power source circuit device in accordance with the fifth embodiment (See FIG. 12.). To be specific, the control circuit device 6e inside the power source circuit device shown in FIG. 13 has such a configuration as the resistors R6 and R7 serving as a part of the RC filter 8 and the capacitor terminal C are excluded from the configuration of the control circuit device 6d, wherein a PWM signal is inputted to the OFF state control circuit 75 by way of the PWM input terminal PWM and the buffer circuit 71. In addition, a constant voltage circuit 76 is provided thereto that produces a constant voltage based on the output voltage being inputting from the output voltage input terminal Vo. Moreover, no “ON/OFF” state control signals are supplied to the “OFF” state control circuit 75.

The constant voltage circuit 76 produces a higher voltage than the constant voltage circuit 61 and provides it to the buffer circuit 71 and the OFF state control circuit 75 by having an output voltage appearing to the cathode of the diode 4 inputted therein. Wherein, the configuration of the constant voltage circuit 76 may have the same configuration as the constant voltage circuit 61 (See FIG. 2.) and may be connected to the output voltage output terminal Vo instead of the input voltage input terminal Vi. In addition, although the buffer circuit 71 is configured in the same manner as the configuration shown in FIG. 2 that is described about the first embodiment, the inverters 713 through 715 are supplied with a constant voltage Vs1 from the constant voltage circuit 76 instead of an internal constant voltage Vs being supplied from the constant voltage circuit 61.

As a result, a PWM signal that is supplied to the OFF state control circuit 75 by way of the buffer circuit 71 becomes a signal that can switch over the switch level between the grounding potential and the potential Vs1 in such a manner as the grounding potential takes an “L” level and the potential Vs1 takes an “H” level. The OFF state control circuit 75 inverts the PWM signal being supplied from the buffer circuit 71 and supplies it to the gate of the transistor Tr5, thereby performing the ON/OFF state control of the transistor Tr5. Hereat, because the OFF state control circuit 75 is supplied with a constant voltage Vs1 from the constant voltage circuit 76, it is possible to increase the voltage at the gate when the transistor Tr5 is turned ON, whereby the withstand voltage at the gate of the transistor Tr5 can be decreased, which results in downsizing of the transistor Tr1.

In the power source circuit device being configured as described hereinabove, The OFF state control circuit 75 turns ON or OFF of the transistor Tr5 based on a PWM signal being supplied from the outside. To be specific, when the PWM signal being supplied from the outside takes an “H” level, the transistor Tr5 is turned OFF, and when the PWM signal being supplied from the outside takes an “L” level, the transistor Tr1 is turned ON. As a result, the higher the duty ratio of the PWM signal being supplied from the outside becomes, the longer the period in which the transistor Tr5 is turned OFF becomes and the smaller the amount of the output current flowing to the load 7 becomes. Therefore, in a case where the load 7 consists of an LED, the light of the LED composing the load 7 can be darkened, by shortening the cycle of a PWM signal being supplied from the outside (to be specific, by increasing the frequency of the PWM signal) so as to make the cycle unable to be followed by human eyes, when the duty ratio of the PWM signal is increased to be high.

Moreover, the resistor R5 that is connected to an inverting input terminal of the error amplifier 68 has only the resistor R1 connected thereto by way of the feedback input terminal FB. Therefore, the PWM comparator 69, the drive circuit 64 and the transistor Tr1 perform so that the electric current flows to the load 7 based on a reference voltage Vref being inputted to the non-inverting input terminal of the error amplifier 68. The performances of the drive circuit 64, the oscillation circuit 66, the adding circuit 67, the error amplifier 68, the PWM comparator 69 and the transistor Tr1 are the same as those of the first embodiment. Therefore, the detailed description thereof will be omitted.

The buffer circuit 71 is supplied with an internal constant voltage from the constant voltage circuit 61 in the same manner as in accordance with the first embodiment, wherein, a PWM signal that places the grounding voltage to be at an “L” level and places the potential Vs to be at an “H” level may be outputted to the OFF state control circuit 75. In addition, the buffer circuit 71 may be omitted; and in the OFF state control circuit 75, a PWM signal that is supplied from the outside by way of the PWM input terminal PWM may be transformed to obtain a waveform of a signal that places the grounding potential to be at an “L” level and places the potential Vs1 to be at an “H” level, and then, the ON/OFF state of the transistor Tr5 may be controlled based on the signal that is transformed to obtain a waveform.

### Seventh Embodiment

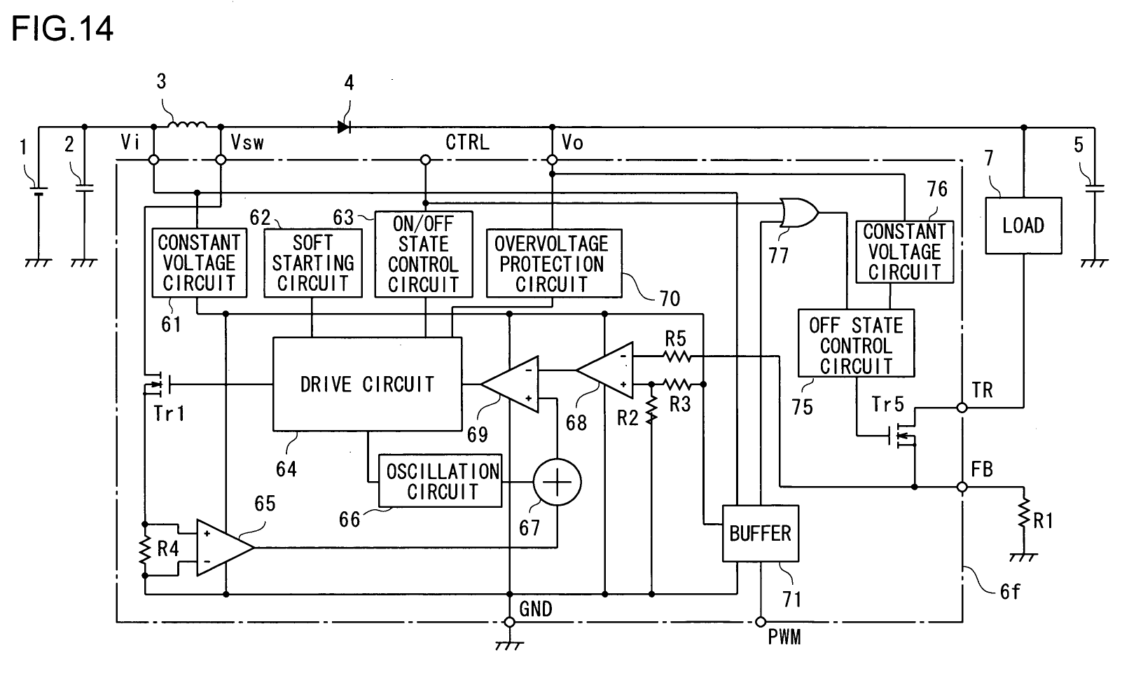

Referring now to the drawings, a seventh embodiment of the present invention will be described hereinafter. FIG. 14 is a block diagram showing the internal configuration of a power supply circuit device in accordance with the present embodiment. In FIG. 14, such portions to be used for the same purposes as used in a conventional power supply circuit device shown in FIG. 13 will be provided with same symbols, and the detailed description thereof will be omitted.

As shown in FIG. 14, the power source circuit device in accordance with the present embodiment has a control circuit device 6f whose configuration is changed from the configuration of the control circuit device 6e in the power source circuit device in accordance with the sixth embodiment (See FIG. 13.). To be specific, in addition to the configuration of the control circuit device 6e, the control circuit device 6f inside the power source circuit device shown in FIG. 14 is provided with an OR circuit 77 to which a PWM signal is inputted from the buffer circuit 71 and an ON/OFF state control signal is inputted from the control signal input terminal CTRL. In accordance with the present embodiment, being different from in accordance with the sixth embodiment, an internal constant voltage Vs is inputted to the buffer circuit 71 from the constant voltage circuit 61.

Being configured as described hereinabove, an output from the OR circuit 77 is supplied to the OFF state control circuit 75, and in addition, an ON/OFF state control signal taking an “H” level becomes an OFF state control signal, while an ON/OFF state control signal taking an “L” level becomes an ON state control signal. To be specific, an OFF state control signal taking an “H” level or a PWM signal taking an “H” level passes through the OR circuit 77 so as to be supplied to the OFF-state control circuit 75. Then, in the OFF state control circuit 75, an output from the OR circuit 77 is inverted to be a signal, which places a grounding potential to be at an “L” level and places a potential Vs1 to be at an “H” level, so as to be supplied to the gate of the transistor Tr5.

As a result, when a PWM signal taking an “H” level is supplied from the outside, or when an OFF state control signal taking an “H” level is supplied, a signal taking an “L” level is supplied from the OFF state control circuit 75, thereby turning OFF the transistor Tr5. In addition, when a PWM signal taking an “L” level is supplied from the outside and an ON state control signal taking an “L” level is supplied, a signal taking an “H” level is supplied from the OFF state control circuit 75, thereby turning the transistor Tr5 ON.

As described hereinabove, the power source circuit device in accordance with the present embodiment is supplied with a function to turn the transistor Tr5 OFF when the power source circuit device in accordance with the fourth embodiment is stopped, in addition to the function of the power source circuit device in accordance with the fifth embodiment. The other performances are the same as those of the power source circuit device in accordance with the fifth embodiment. Therefore, the detailed description thereof will be omitted.

### Eighth Embodiment

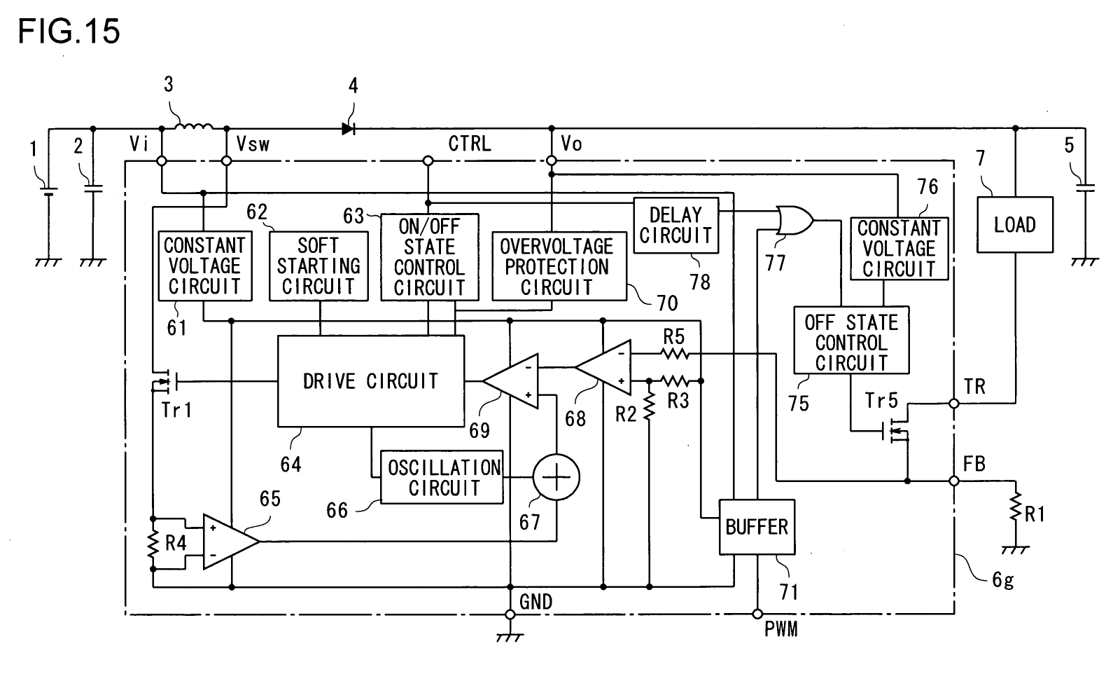

Referring now to the drawings, an eighth embodiment of the present invention will be described hereinafter. FIG. 15 is a block diagram showing the internal configuration of a power supply circuit device in accordance with the present embodiment. In FIG. 15, such portions to be used for the same purposes as used in a conventional power supply circuit device shown in FIG. 14 will be provided with same symbols, and the detailed description thereof will be omitted.

As shown in FIG. 15, in the power source circuit device in accordance with the present embodiment, the configuration of the control circuit device 6f in the power source circuit device in accordance with the seventh embodiment (See FIG. 14.) is changed. To be specific, the control circuit device 6g in the power source circuit device shown in FIG. 15 is configured in a manner that in addition to a configuration of the control circuit device 6f, a delay circuit 78 is provided that delays an ON/OFF state control signal being outputted from the control signal input terminal CTRL so as to be inputted to the OR circuit 77.

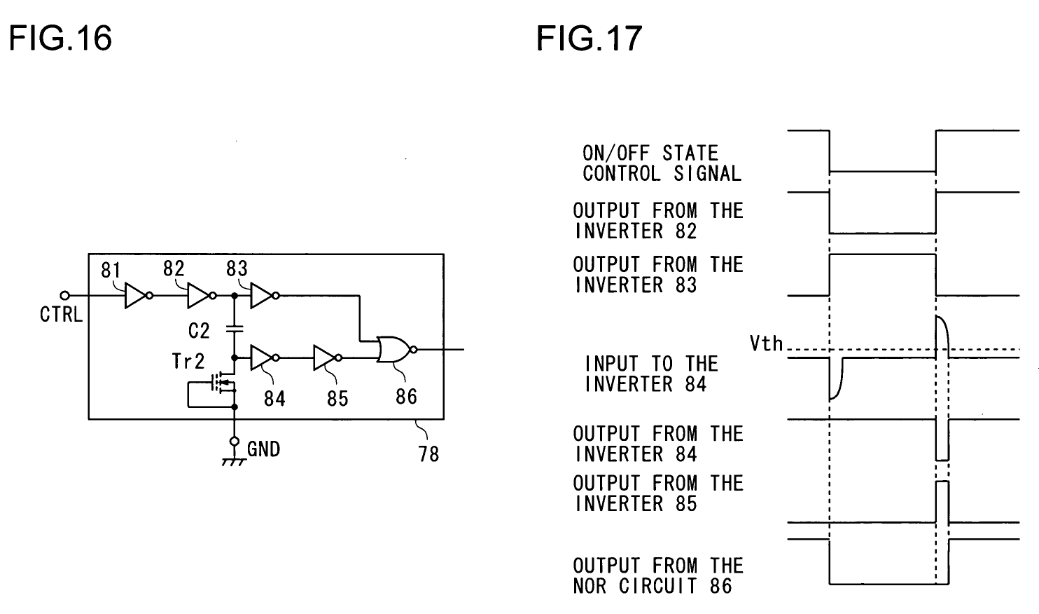

The configuration of the delay circuit 78 will be described hereinafter by referring to the circuit diagram shown in FIG. 16. Same as the seventh embodiment, an ON/OFF state control signal taking an “H” level becomes an OFF state control signal, while an ON/OFF state control signal taking an “L” level becomes an ON state control signal. Wherein, as shown in FIG. 16, the delay circuit 78 is provided with an inverter 81 to which an ON/OFF state control signal is inputted; an inverter 82 to which an output from the inverter 81 is inputted; an inverter 83 to which an output from the inverter 82 is inputted; a capacitor C2 that has one end thereof connected to the output side of the inverter 82; an inverter 84 that has the input side thereof connected to the other end of the capacitor C2; an inverter 85 to which an output of the inverter 84 is inputted; a transistor Tr6 serving as an N-channel metal-oxide-semiconductor field effect transistor that has a drain thereof connected to the input side of the inverter 84 and has a gate and a source thereof grounded; and an NOR circuit 86 to which outputs of the inverters 83 and 85 are inputted.

The performance of the delay circuit 78 having such a configuration as mentioned hereinabove will be described hereafter by referring to a timing chart shown in FIG. 17. Being configured in this way, since a constant electric current source that is connected to the capacitor C2 is constructed, having the transistor Tr6 serve as a depression type of metal-oxide-semiconductor field effect transistor, an electric power is stored in the capacitor C2 or discharged from the capacitor C2, whereby the potential on the side of an input of the inverter 84 varies in accordance with a time constant that is determined by the capacitor C2 and the transistor Tr6.

To be specific, as shown in FIG. 17, when the output of the inverter 82 is switched over from the “L” level to the “H” level, the potential on the side of the input of the inverter 82 becomes a value that is close to the “H” level. Subsequently, the electric power is stored in the capacitor C2, which makes the voltage of the capacitor C2 large, whereby the potential on the side of the input of the inverter 84 is decreased to be at the “L” level. On the contrary, when the output of the inverter 82 is switched over from the “H” level to the “L” level, the potential on the side of the input of the inverter 84 becomes a value that is close to the “−H” level. Subsequently the electric power is discharged from the capacitor C2, which makes the voltage of the capacitor C2 small, whereby the potential on the side of the input of the inverter 84 is increased to be at the “L” level. In addition, the signal level of the output of the inverter 82 is switched over to be a same value as that of an ON/OFF state control signal.

Additionally, because the output of the inverter 82 is inverted by the inverter 83, the output of the inverter 83 supplies a signal that is inverted from an ON/OFF state control. To be specific, when an ON state control signal is inputted, the output of the inverter 83 takes an “H” level, and when an OFF state control signal is inputted, the output of the inverter 83 takes an “L” level.

Moreover, when a potential appearing to a node between the capacitor C2 and the transistor Tr6 is larger than a predetermined signal level Vth, the inverter 84 supplies the inverter 85 with an output that takes an “L” level. On the contrary, when a potential appearing to the node between the capacitor C2 and the transistor Tr6 is smaller than the predetermined signal level Vth, the inverter 84 supplies the inverter 85 with an output that takes an H” level. Then, the inverter 85 inverts the output of the inverter 84.

In consequence, in a case where the potential on the side of the input of the inverter 84 takes an “H” level, an output taking an “H” level is supplied from the inverter 85, and in the other cases, an output taking an “L” level is supplied from the inverter 85. To be specific, as shown in FIG. 17, when the output of the inverter 82 is switched over from the “L” level to the “H” level, the output of the inverter 85 takes an “H” level for a period according to the time constants of the capacitor C2 and the transistor Tr6, and in the other cases, the output of the inverter 85 takes an “L” level.

When either of the outputs of the inverters 83 and 85 takes an “H” level, the output of the NOR circuit 86 to which the outputs of the inverters 83 and 85 are supplied takes an “L” level; and on the other hand, when both outputs of the inverters 83 and 85 take an “L” level, the outputs of the NOR circuit 86 takes an “H” level. As a result, when an ON state control signal taking an “L” level is inputted, the output of the inverter 83 takes an “H” level, so that the output of the NOR circuit 86 takes an “L” level. Then, when a control signal to be inputted is switched over to be an OFF state control signal that takes an “H” level, the output of the inverter 85 takes an “H” level for a predetermined time, and during this period, the output of the NOR circuit 86 takes an “L” level. After that, the output of the inverter 85 takes an “L” level, so that the output of the NOR circuit 86 is switched over to take an “H” level.

By providing a delay circuit 78 in such a manner as described hereinabove, it is possible to delay the input timing of an OFF state control signal to be inputted to the OFF state control 74 by way of the OR circuit 77 for a period according to the time constants of the capacitor C2 and the transistor Tr6. In consequence, when an OFF state control signal is supplied, the drive circuit 64 is turned OFF so as to stop the switching control performance of the transistor Tr1, and then, after a predetermined time passes, the transistor Tr5 is turned OFF. As a result, the transistor Tr5 is turned ON for a period of the delay, which can discharge the electric power from the output capacitor 5 to be initialized. The other configurations in accordance with the present embodiment are the same as those of the power source circuit device in accordance with the seventh embodiment. Therefore, the detailed descriptions thereof will be omitted.

In accordance with the present embodiment, the delay circuit 78 has such a circuit configuration as shown in FIG. 16. However, the delay circuit 78 may have other configurations as long as the OFF state control signal is supplied by being delayed, so as to turn the transistor Tr5 ON for some time in order that the output capacitor can have the electric power therein discharge therefrom after the operation of the power source circuit device is stopped by an ON/OFF state control signal.

In accordance with the seventh and the eighth embodiments, either an internal constant voltage Vs being supplied from the constant voltage circuit 61 or an internal constant voltage Vs1 being supplied from the constant voltage circuit 76 may be employed as a bias voltage for the OR circuit 77. Additionally, in accordance with the eighth embodiment, either an internal constant voltage Vs being supplied from the constant voltage circuit 61 or an internal constant voltage Vs1 being supplied from the constant voltage circuit 76 may be employed as a bias voltage for eachy element inside the delay circuit 78. Moreover, same as the fifth embodiment, an internal constant voltage Vs1 being supplied from the constant voltage circuit 76 may be applied to the buffer circuit 71, wherein an ON/OFF state control signal is inverted to a signal that is switched over between a potential Vs1 and a grounding potential.

Furthermore, in accordance with the seventh and the eighth embodiments, an OR circuit 77 is installed, so as to have an OFF state control circuit 75 in the subsequent stage invert a signal of an OR circuit 77. However, as long as the transistor Tr5 has such a circuit configuration as can control an ON/OFF state thereof in accordance with the duty ratio of a PWM signal and can control an ON/OFF thereof in accordance with an ON/OFF state control signal, the OR circuit 77 and the OFF state control circuit 75 may have other configurations. In addition, an ON/OFF state control signal may take an “H” level in a case of supply of an ON state control signal, but may take an “L” level in a case of supply of an OFF state control signal.

In accordance with the fifth through the eighth embodiments, the configuration in accordance with the second embodiment or the third embodiment may be provided, so that when the amount of an output current to the load 7 is minimal, the control of the amount of the output current to the load 7 by a PWM signal being supplied from the outside may be stopped, and the amount of the output to the load 7 may be controlled by a switching control of a reference potential being supplied from the reference potential switching circuit 72. Moreover, by providing an overheating protection circuit to stop the operation of the drive circuit 64 by detecting the overheating in the neighborhood of the transistor Tr1 that is associated with the operation of the drive circuit 64, the power source circuit device may be prevented from a failure or a damage due to overheating.

The present invention is applicable to power source circuit devices serving as a direct current voltage chopper circuit devices that step up or step down an output voltage. In addition, the present invention is applicable to power supply circuit devices that can adjust the brightness of an LED by employing the LED as a load which outputs a voltage. Moreover, when an LED is employed as a load, the present invention can be applied to a case where a white LED is employed as an illumination light source of liquid crystal display devices.

What is claimed is:

1. A power supply circuit device comprising:
a voltage transforming circuit that is connected to a direct current power source;
a rectifying circuit that is connected to the voltage transforming circuit;
a first switching element that adjusts an electric power to be supplied to the rectifying circuit by switching over the voltage transforming circuit;
a drive circuit that controls an ON/OFF state of the first switching element;
a current-detecting circuit that detects an electric current flowing through a load being connected to the rectifying circuit;
a PWM signal producing circuit that produces a first PWM signal for instructing the control of the ON/OFF state being performed by the drive circuit by comparing, with a reference value, a signal level of a current-detecting signal indicating a value of an electric current being detected by the current-detecting circuit;
a first constant voltage circuit that produces a constant internal constant voltage from an external direct current voltage, and
a buffer circuit into which a second PWM signal is inputted to control the value of the electric current flowing through the load from outside and in which an element serving as a last stage is biased by the internal constant voltage being fed from the first constant voltage circuit and the second PWM signal is formed to obtain a waveform so as to be outputted.

2. A power supply circuit device as descried in claim 1, further comprising:
a second switching element that is connected between the current-detecting circuit and the load and cuts off an electrical connection of the load when a power supply circuit device is turned OFF;
wherein, on receiving an OFF state control signal to turn a power source circuit device OFF, an ON/OFF state control operation of the first switching element being performed by the drive circuit is stopped and the second switching element is turned OFF.

3. A power source circuit device as described in claim 1, further comprising:
a combining circuit that combines the second PWM signal being outputted from the buffer circuit and transformed to obtain a waveform and the current-detecting signal being outputted from the current-detecting circuit so as to be outputted to the PWM signal producing circuit.

4. A power supply circuit device as described in claim 3, further comprising:
a second switching element that is connected between the current-detecting circuit and the load and cuts off an electrical connection of the load when a power source circuit device is turned OFF;
wherein, on receiving an OFF state control signal to turn a power source circuit device OFF, an ON/OFF state control operation of the first switching element being performed by the drive circuit is stopped and the second switching element is turned OFF.

5. A power supply circuit device as described in claim 3,
wherein, the combining circuit is a filter comprising a resistor and a capacitor.

6. A power supply circuit device as described in claim 5, further comprising:
a second switching element that is connected between the current-detecting circuit and the load and cuts off an electrical connection of the load when a power source circuit device is turned OFF;
wherein, on receiving an OFF state control signal to turn a power source circuit device OFF, an ON/OFF state control operation of the first switching element being performed by the drive circuit is stopped and the second switching element is turned OFF.

7. A power supply circuit device as described in claim 1, further comprising:
a second switching element that is connected between the current-detecting circuit and the load and cuts off an electrical connection of the load when a power source circuit device is turned OFF; and
an OFF state control circuit that controls an ON or OFF state of the second switching element in accordance with the second PWM signal.

8. A power supply circuit device as described in claim 7, further comprising:
a second constant voltage circuit that produces a constant voltage that biases the OFF state control circuit based on an output voltage being supplied from the rectifying circuit.

9. A power supply circuit device as described in claim 7,
wherein, on receiving an OFF state control signal to turn a power source circuit device OFF, an ON/OFF state control operation of the first switching element being performed by the drive circuit is stopped and the second switching element is turned OFF.

10. A power supply circuit device as described in claim 9, further comprising:
a second constant voltage circuit that produces a constant voltage that biases the OFF state control circuit based on an output voltage being supplied from the rectifying circuit.

11. A power supply circuit device as described in claim 9 comprising:
a delay circuit that delays the OFF state control signal and supplies the OFF state control signal to the OFF state control circuit,
wherein, on receiving an OFF state control signal to turn a power source circuit device OFF, an ON/OFF state control operation of the first switching element being performed by the drive circuit is stopped and the OFF state control circuit turns OFF the second switching element after a predetermined time passes.

12. A power supply circuit device as described in claim 10, further comprising:
a second voltage circuit that produces a constant voltage that biases the OFF state control circuit based on an output voltage being supplied from the rectifying circuit.

13. A power supply circuit device as described in claim 1, further comprising:
a first voltage-dividing circuit that produces a reference voltage for the first constant voltage circuit to divide an external direct current voltage so as to produce the internal constant voltage;
wherein, the first voltage-dividing circuit is constructed by connecting in series a depression type of transistor and an enhancement type of transistor having a control electrode connected to a first electrode.

14. A power supply circuit device as described in claim 1, wherein, the first constant voltage circuit comprises:
a comparator that compares a reference voltage for producing the internal constant voltage with an internal constant voltage being produced;
an amplifying element that amplifies an output from the comparator; and
a second voltage-dividing circuit that has resistors being connected to an output side of the amplifying element connected in series;
wherein, a voltage being supplied from the second voltage-dividing circuit serves as the internal constant voltage.

15. A power supply circuit device as described in claim 14,
wherein, resistors composing the second voltage-dividing circuit are variable resistors.

16. A power supply circuit device as described in claim 1,
wherein, the first constant voltage circuit produces an internal constant voltage based on a direct current voltage being supplied from the direct current power source.

17. A power supply circuit device as described in claim 1, further comprising:
a reference value switching circuit that switches over a reference value to be supplied to the PWM signal producing circuit;
wherein, an output current to be supplied to the load is adjusted by having the reference value switched over by the reference value switching circuit.

18. An electronic apparatus comprising:
a power source circuit device as described in claim 1;
wherein, a power source circuit device is operated by being supplied with an output voltage that is supplied from the power source circuit device.

19. An electronic apparatus as described in claim 18, further comprising:
a light-emitting diode that is supplied with an output voltage from the power supply circuit device.
